(19) United States
(12) Patent Application Publication
(10) Pub. No.: US 2026/0102959 A1
(43) Pub. Date: Apr. 16, 2026

(54) METHODS FOR EXTRUDING ELASTOMERIC COMPOSITIONS

(71) Applicant: Cabot Corporation, Boston, MA (US)

(72) Inventors: Martin C. Green, Boxborough, MA (US); Carlos Andres Echavarria Yepes, Chelmsford, MA (US); Dhaval A. Doshi, Lexington, MA (US); Kento Uemura, Takasago-Shi (JP); Hiroomi Katano, Takasago-shi (JP); Quentin Hartley, Hudson, OH (US); David P. Cacciola, Woburn, MA (US)

(21) Appl. No.: 19/358,085

(22) Filed: Oct. 14, 2025

Related U.S. Application Data
(60) Provisional application No. 63/707,362, filed on Oct. 15, 2024.

(51) Int. Cl. B29C 48/30; B29C 48/00; B29K 21/00

(52) U.S. Cl. CPC B29C 48/30; B29C 48/0022; B29K 2021/003

(57) ABSTRACT

Disclosed herein are methods for processing a composition comprising an elastomer and filler. The method comprises processing the composition through a single screw or twin-screw extruder having a die with at least one non-circular slot extending through the die body in which the non-circular slot has an inner surface that is tapered. Also disclosed are extrudates resulting from the processing.

### FIELD OF THE INVENTION

This disclosure relates generally to methods for processing elastomeric compositions, such as methods of processing an elastomeric composition through a die of an extruder.

### BACKGROUND

Numerous products can be formed using elastomeric compositions in which reinforcing filler material is dispersed in any of various synthetic elastomers, natural rubber or elastomer blends. Carbon black and silica, for example, are widely used to reinforce natural rubber and other elastomers. It is common to produce a resulting composite (masterbatch), that is, a premixture of reinforcing material, elastomer, and/or various optional additives, e.g., in a batch mixer. Such masterbatches are then compounded with processing and curing additives and upon curing, generate numerous products, during downstream or later processing step(s). Such products include, for example, pneumatic and non-pneumatic or solid tires for vehicles, including the tread portion including cap and base, undertread, inner liner, sidewall, wire skim, carcass and others. Other products include, for example, engine mounts, bushings, conveyor belts, windshield wipers, rubber components for aerospace and marine equipment, vehicle track elements, seals, liners, gaskets, wheels, bumpers, anti-vibration systems and the like.

### SUMMARY

### One Aspect is a Method for Processing a Composition, the Method Comprising:

feeding the composition to a screw extruder, wherein the composition comprises at least one elastomer and at least one filler;
flowing the composition through the extruder by applying a shearing force on the composition; and
extruding the composition through a stationary die provided at an exit end of the extruder, wherein the extruding comprises:
forcing the composition through at least one non-circular slot extending through a die body of the stationary die from a first face of the die body to an opposing face of the die body that opposes the first face forming a passageway such that the composition is forced across an inner surface of the at least one non-circular slot, wherein the inner surface is tapered such that a first opening at one of the first face or the opposing face is smaller than a second opening at the other of the first face or the opposing face.

### Another Aspect is a Method for Processing a Composition, the Method Comprising:

feeding the composition to a screw extruder, wherein the composition comprises at least one elastomer and at least one filler;
flowing the composition through the extruder by applying a shearing force on the composition; and
extruding the composition through a stationary die provided at an exit end of the extruder, wherein the extruding comprises:
forcing the composition through at least one slot extending through a die body of the stationary die from a first face of the die body to an opposing face of the die body that opposes the first face forming a passageway such that the composition is forced across an inner surface of the at least one slot, wherein the inner surface is tapered such that a first opening at one of the first face or the opposing face is smaller than a second opening at the other of the first face or the opposing face, and wherein the first and second openings are non-concentric.

### Another Aspect is a Method for Processing a Composition, the Method Comprising:

feeding the composition to a screw extruder, wherein the composition comprises at least one elastomer and at least one filler having a filler loading of at least 20 phr, wherein the composition is substantially free of rubber chemicals;
flowing the composition through the extruder by applying a shearing force on the composition.
extruding the composition through a die provided at an exit end of the extruder, wherein the die comprises a die body having a first face and an opposing face, wherein the extruding includes traversing the composition through at least one slot extending through the die body from the first face to the opposing face that forms a passageway; and
cutting the extruded composition with an associated blade of the die, wherein one or more of the die or the associated blade is rotatable.

### Another Aspect is a Method for Processing a Composition, the Method Comprising:

feeding the composition to a screw extruder, wherein the composition comprises at least one elastomer and at least one filler having a filler loading of at least 20 phr, and the composition has a dynamic storage modulus of at least 900 kPa measured at 0.3% strain amplitude G′ (0.3%) at 1 Hz frequency and 100° C.;
flowing the composition through the extruder by applying a shearing force on the composition;
extruding the composition through a die provided at an exit end of the extruder, wherein the die comprises a die body having a first face and an opposing face, wherein the extruding includes traversing the composition through at least one slot extending through the die body from the first face to the opposing face that forms a passageway; and
cutting the extruded composition with an associated blade of the die, wherein one or more of the die or the associated blade is rotatable.

### Another Aspect is a Method for Processing a Composition, the Method Comprising:

feeding the composition to screw extruder, wherein the composition comprises at least one elastomer and at least one filler;
flowing the composition through the extruder by applying a shearing force on the composition, wherein the screw or screws of the extruder each comprise (i) a shaft having a longitudinal axis, a first end, and a second exit end, and (ii) a screw flight provided on the shaft along the longitudinal axis from the first end to the second exit end for applying the shearing force on the composition; and
extruding the composition through a die provided at the second exit end of each screw or screws of the extruder, wherein the second exit end has an end portion with a flat face formed by the shaft and the screw flight, and wherein the flat face has a surface area ranging from 20% to 70% of an area defined by an outer diameter of the screw flight.

### Another Aspect is a Method for Processing a Composition, the Method Comprising:

feeding the composition to a screw extruder, wherein the composition comprises at least one elastomer and at least one filler;
flowing the composition through the extruder by applying a shearing force on the composition, wherein the screw or screws of the extruder each comprise (i) a shaft having a longitudinal axis, a first end, and a second exit end, and (ii) screw flight provided on the shaft along the longitudinal axis from the first end to the second exit end for applying the shearing force on the composition; and
extruding the composition through a die provided at the second exit end of the screw or screws, wherein the second exit end has an end portion with a flat face formed by the shaft and the screw flight, and wherein at least a portion of the flat face is configured to have a surface area ranging from 0.9 to 3 times an area of a slot of a die of the extruder.

In some embodiments, the composition or composite comprises an elastomer and a filler at a loading of at least 20 phr. In some embodiments, the composition or composite is substantially free of rubber chemicals. In some embodiments, the composition or composite has a filler loading of at least 20 phr, and the composition or composite has a dynamic storage modulus of at least 900 kPa measured at 0.3% strain amplitude, G′ (0.3%), at 1 Hz frequency and 100° C. In some embodiments, the extruder and/or die are configured for the composition to have a length ranging from 20 mm to 150 mm and a thickness ranging from 2 mm to 20 mm. In some embodiments, the composition is an elastomer composite.

In some embodiments, the composition or composite has a liquid content ranging from 0.3% to 10% by weight relative to the total weight of the composition.

In some embodiments, the screw extruder is a single screw or twin-screw extruder. In some embodiments, the extruder is a twin-screw extruder and includes twin screws provided as a pair of intermeshing screws. In some embodiments, the extruder is a twin-screw extruder and includes twin screws tapered towards each other. In some embodiments, the screw or screws is configured to heat and/or cool the elastomeric material.

In some embodiments, an inner surface of the slot is tapered such that a first opening at one of the first face or the opposing face is smaller than a second opening at the other of the first face or the opposing face. The first and second openings can be concentric or non-concentric. In some embodiments, the first opening is at the first face such that the slot is tapered outward. In some embodiments, the first opening is at the opposing face such that the slot is tapered inward. In some embodiments, the taper of the inner surface of the at least one slot is configured to maintain the composition on a cutting edge of the at least one slot that substantially aligns with a direction of a vector combining tangential and radial forces imposed on the composition being extruded through the die.

In some embodiments, at least one wall of the inner surface of the slot is substantially flat, concave surface, or convex. In some embodiments, at least one wall of the tapered inner surface of the at least one slot is beveled. In some embodiments, a cross-section of the inner surface of the slot defines a taper angle ranging from 20° to 60°, e.g., from 20° to 50°.

In some embodiments, the at least one slot defines an open area covering 20% to 60% of the total area the first face or the opposing face. In some embodiments, the at least one slot has a radial length to circumferential width ratio ranging from 1.1:1 to 10:1, and preferably ranging from 1.5:1 to 4:1, and most preferably ranging from 2:1 to 3:1.

In some embodiments, the at least one slot is configured to substantially align with a direction of a vector combining tangential and radial forces on the composition being extruded through the die from the extruder. In some embodiments the at least one slot has an elongated shape. In some embodiments, the at least one slot has an elliptical or ovular shape. In some embodiments, at least one of the first and second openings of the at least one slot has a stadium shape with two parallel linear edges. In some embodiments, a center line aligned with longest dimension of the at least one slot is offset from an axial axis of a corresponding screw of the extruder. In some embodiments, a center line aligned with longest dimension of the at least one slot is offset from an axial axis of a corresponding screw of the extruder by an angle ranging from 20° to 50°, e.g., from 20° to 45°, or from 20° to 40°, or from 25° to 50°, or from 25° to 45°, or from 25° to 40°, or from 30° to 50°, or from 30° to 45°, or from 30° to 40°. In some embodiments, the at least one slot is bean-shaped. In some embodiments, the at least one slot has at least one rippled or serrated cutting edge. In some embodiments, the at least one slot has at least one straight cutting edge. In some embodiments, the associated blade has at least one of a linear, circular, rippled, or serrated edge. In some embodiments, the associated blade is at least one edge of at least one opening of the die.

In some embodiments, the at least one slot comprises a plurality of slots. In some embodiments, a number of sets of the plurality of slots correspond to a number of screws provided in the extruder. In some embodiments, a midpoint of each set of the plurality of slots is substantially coaxially aligned with the corresponding screw provided in the extruder. In some embodiments, the at least one slot includes from 1 to 100 slots, and preferably from 2 to 100 slots, and most preferably from 4 to 40 slots. In some embodiments, the associated blade is external to the die and configured to cut the extruded composition as the extruded composition exits the die.

Some embodiments further comprise a heating element for heating the composition being extruded through the die, wherein the heating element is configured to be heated at a temperature ranging from 90° C. to 150° C., e.g., from 110° C. to 150° C., or from 130° C. to 150° C. In some embodiments, a clearance between the die and the screw extruder ranges from 0.5 mm to 5.0 mm, e.g., from 0.8 mm to 2.0 mm, or from 1.0 mm to 2.0 mm. In some embodiments, the flowing of the composition through the extruder occurs at a rate ranging from 0.0005 m³/min to 1.0 m³/min. In some embodiments, the flowing of the composition through the extruder occurs at a rate ranging from 0.5 kg/min to 1000 kg/min in which the density of the extrudate ranges from 0.90 to 1.3. In some embodiments, the composition is extruded through the exit end at an exit velocity ranging from 0.05 m/min to 30 m/min, e.g., from 0.1 m/min to 30 m/min, or from 0.1 m/min to 16 m/min. In some embodiments, the extruder screw or twin-screws rotates at a speed ranging from 5 rpm to 50 rpm. In some embodiments, the extruder is configured to maintain a metal temperature of the single screw or twin-screw extruder ranging from 50° C. to 150° C.

In some embodiments, the screw is tapered and the surface area of the flat face ranges from 20% to 70% of the area defined by the maximum outer diameter of the screw flight. In some embodiments, the screw is tapered and the surface area of the flat face ranges from 20% to 70% of the area defined by the outer diameter of the screw flight at the second exit end. In some embodiments, the surface area of the flat face ranges from 20% to 70% of the area defined by the outer diameter of the screw flight, or ranges from 20% to 60% of the area defined by the outer diameter of the screw flight, or ranges from 20% to 50% of the area defined by the outer diameter of the screw flight, or from 20% to 40% of the area defined by the outer diameter of the screw flight.

In some embodiments, the flat face of the screw has a geometry having a circular portion and a wedge portion that is at least partially formed by the screw flight, wherein a dimension of the wedge portion to a center of the circular portion is at least 70% of a radius formed by a widest dimension of the screw flight. In some embodiments, the wedge portion defines a sector having an angle ranging from 20° to 100°.

In some embodiments, at least portion of the flat face is configured to align with the slot such that the at least portion of the flat face covers an entirety of the slot of the die with each rotation of the screw. In some embodiments, the at least portion of the flat face has the surface area ranging from 0.9 to 2 times the area of the slot, or ranging from 0.9 to 1.5 times the area of the slot.

In some embodiments, a thickness of the end portion having the flat face ranges from 5 mm to 15 mm.

In some embodiments, the end portion of a screw having the flat face is formed by a truncation of the second end of the shaft.

In some embodiments, the screw or screws of the extruder each comprise (i) a shaft having a longitudinal axis, and (ii) a screw flight provided on the shaft along the longitudinal axis, wherein adjacent the exit end of the extruder is an end portion of the screw or screws with a flat face formed by the shaft and the screw flight, and wherein the flat face has a surface area ranging from 20% to 70% of an area defined by an outer diameter of the screw flight. In some embodiments, the screw or screws of the extruder each comprise (i) a shaft having a longitudinal axis, and (ii) a screw flight provided on the shaft along the longitudinal axis, wherein adjacent the exit end of the extruder is an end portion of the screw or screws with a flat face formed by the shaft and the screw flight, and wherein the flat face is configured to have a surface area that is between at or about 0.9 and 3 times an area of the at least one slot.

Another aspect is a method of processing a composite in an integrated manufacturing operation, comprising:
feeding the composite to a screw extruder;
flowing the composite through the extruder by applying a shearing force on the composition; and
extruding the composite through a die provided at an exit end of the extruder such that the extruded composite has an irregular shape.

Another aspect is a method for extruding a material, the method comprising:
feeding the material to a screw extruder;
flowing the material through the extruder by applying a shearing force on the material;
extruding the material through a die plate provided at an exit end of the extruder,
wherein the elastomeric extrudate has an irregular shape, wherein the extrudate has an angle of curvature in at least one dimension ranging from 50° to 160°, and
wherein a length of the extrudate is no more than 500 mm.

Another aspect is an extrudate resulting from any process disclosed herein.

In some embodiments, the extrudate is substantially free of rubber chemicals. In some embodiments, the extrudate has a dynamic storage modulus of at least 900 kPa measured at 0.3% strain amplitude, G′ (0.3%), at 1 Hz frequency and 100° C., and preferably ranging from 900 kPa to 3000 kPa at 1 Hz frequency and 100° C.

In some embodiments, the composition or composite or extrudate consists essentially of: (i) the at least one elastomer and the at least one filler, or (ii) the at least one elastomer, the at least one filler, and at least one antidegradant, or (iii) the at least one elastomer, the at least one filler, and at least one coupling agent, or (iv) the at least one elastomer, the at least one filler, at least one antidegradant, and at least one coupling agent.

In some embodiments, the composition or composite or extrudate consists of: (i) the at least one elastomer and the at least one filler, or (ii) the at least one elastomer, the at least one filler, and at least one antidegradant, or (iii) the at least one elastomer, the at least one filler, and at least one coupling agent, or (iv) the at least one elastomer, the at least one filler, at least one antidegradant, and at least one coupling agent.

Another aspect is an elastomeric extrudate comprising at least one elastomer and at least one filler in an amount of at least 20 phr, wherein the extrudate has:
a length no more than 500 mm; and
an angle of curvature in at least one dimension ranging from 50° to 160°.

In some embodiments, the extrudate has a main body portion that has the angle of curvature in at least one dimension ranging from 50° to 160°. In some embodiments, the extrudate further includes a width, wherein an aspect ratio of the length to the width of the extrudate ranges from 1.5:1 to 5:1. In some embodiments, the angle of curvature is in at least two dimensions. In some embodiments, the extrudate has a scoop shape. In some embodiments, the extrudate has a thickness ranging from 2 mm to 25 mm, preferably from 2 mm to 20 mm, and preferably from 5 mm to 15 mm. In some embodiments, the width of the extrudate ranges from 20 to 300 mm, or from 20 to 150 mm, or from 20 to 75 mm. In some embodiments, the extrudate has a surface area ranging from 0.0005 to 0.01 m², and preferably ranging from 0.0005 to 0.007 m².

In some embodiments, the at least one elastomer is selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, halogenated butyl rubber, polychloroprene rubber, nitrile rubber, hydrogenated nitrile rubber, polysulfide rubber, polyacrylate elastomers, fluoroelastomers, perfluoroelastomers, silicone elastomers, and blends thereof. In some embodiments, the elastomeric extrudate comprises at least 50% natural rubber. In some embodiments, the elastomeric extrudate further comprises at least one of styrene-butadiene rubber and polybutadiene rubber,

In some embodiments, the at least one filler is selected from carbon black, carbonaceous materials, carbon black, silica, nanocellulose, lignin, clays, nanoclays, metal oxides, metal carbonates, pyrolysis carbon, graphenes, graphene oxides, reduced graphene oxide, carbon nanotubes, single-wall carbon nanotubes, multi-wall carbon nanotubes, carbon nanostructures, fragments of carbon nanostructures, or fractured multiwall carbon nanotubes, or combinations thereof, and coated and treated materials thereof. In some embodiments, the filler is selected from carbon black, silica, silicon-treated carbon black, and combinations thereof. In some embodiments, the filler is carbon black. In some embodiments, the filler is silica. In some embodiments, the filler is a blend comprising carbon black and silica.

In some embodiments, the elastomeric extrudate is formed by extruding an elastomeric composition through a screw extruder, which can be a single screw or twin-screw extruder.

In some embodiments, the single screw or twin-screw extruder is configured to cause the material to flow by applying a shearing force on the material, the extruder further comprising:
a die provided at an exit end of the single screw or twin-screw extruders for extruding the material,
wherein the die comprises:
a stationary die body,
   a first face of the die body,
   an opposing face of the die body that opposes the first face, and
   at least one slot extending through the die body from the first face to the opposing face forming a passageway,
   wherein the at least one slot has an inner surface that is tapered such that a first opening at one of the first face or the opposing face is smaller than a second opening at the other of the first face or the opposing face, wherein the at least one slot is configured to substantially align with a direction of a vector combining tangential and radial forces imposed on the material being extruded through the die from the extruder.

Another aspect is a plurality of elastomeric extrudates comprising an extrudate resulting from any process disclosed herein.

Another aspect is a plurality of elastomeric extrudes each having an irregular shape and comprising at least one elastomer and at least one filler in an amount of at least 20 phr, wherein:
at least 75% of the plurality of extrudates has a length no more than 500 mm; and
at least 75% of the plurality of elastomeric extrudates has an angle of curvature in at least one dimension ranging from 50° to 160°.

In some embodiments, at least 90% of the plurality of extrudates has an angle of curvature in at least one dimension ranging from 50° to 160°. In some embodiments, at least 75%, and preferably at least 80%, and more preferably at least 90% of the plurality of extrudates has a width, wherein an aspect ratio of the length to the width of the extrudate ranges from 1.5:1 to 5:1. In some embodiments, at least 75% of the plurality of extrudates has a thickness ranging from 2 mm to 25 mm.

Another aspect is a bale comprising the plurality of elastomeric extrudates as disclosed herein, wherein the bale has a void volume ranging from 50% to 90%.

### BRIEF DESCRIPTION OF THE DRAWING(S)

References are made to the accompanying drawings that form a part of this disclosure, and which illustrate embodiments in which the systems and methods described in this Specification can be practiced.

FIG. 1 is an illustrative embodiment of an extruder according to the disclosure.

FIG. 2 is an illustrative embodiment of a twin-screw extruder according to the disclosure.

FIGS. 3A, 3B, and 3C illustrate a die for an extruder, according to an embodiment.

FIGS. 4A, 4B illustrate a die for an extruder, according to another embodiment.

FIG. 5 illustrates a die for an extruder, according to still yet another embodiment.

FIGS. 6A, 6B, and 6C illustrate an embodiment of a screw for an extruder, according to an embodiment.

FIGS. 7A, 7B, and 7C illustrate an embodiment of another screw for an extruder, according to an embodiment.

FIG. 8A illustrates parameters for determining angle of curvature.

FIGS. 8B-8D, 9B are schematic illustrations of an extrudate according to an embodiment.

FIG. 9 is a schematic illustration of a bale formed from the extrudate according to an embodiment.

FIGS. 10A and 10B are photographs of extrudates formed by extruding first stage (FIG. 10A) and second stage (FIG. 10B) elastomer composites through a die plate of FIGS. 3A-3C.

Representative extrudates prepared for image analysis are shown in the photographs of FIG. 11A (1st stage) and 11B (2nd stage).

FIG. 12A (first stage) and 12B (second stage) are outlines of the extrudates of FIGS. 11A and 11B, respectively.

FIGS. 13A and 13B are ellipses corresponding to the outlines of FIGS. 12A and 12B, respectively.

Like reference numbers represent like parts throughout.

### DETAILED DESCRIPTION

Disclosed herein are methods and apparatus for processing a composition, such as, for extruding elastomeric material. In one aspect, this disclosure relates to a method for processing a composition through a die of an extruder, which can result in formation of discrete pieces (“extrudate”) having uniform or substantially uniform sizes and/or formation of discrete pieces having a curved shape. Another aspect provides a plurality of extrudates comprising discrete pieces and/or having a curved shape that can enable a bale having higher void fractions.

While various systems and methods are provided for extruding elastomeric material into an extrudate, e.g., into pellets, granules, or the like, the methods and apparatus as disclosed herein are provided for processing an elastomeric composition, e.g., a composition comprising elastomer and filler. In some instances, certain composites are tough (e.g., having a high dynamic storage modulus) and can be difficult to process, e.g., cut into substantially uniform pieces, using existing or conventional twin-screw rollers (TSR) and stationary knife device design(s). As such, the methods and apparatuses as disclosed herein are directed to processing and providing extruded compositions of discrete sizes having substantial uniformity in size and/or shape and/or for extruding a composite. In some embodiments, the elastomeric composition is a composition (e.g., a composite) that is substantially free of rubber chemicals. In some embodiments, the elastomeric composition has a dynamic storage modulus of at least 900 kPa measured at 0.3% strain amplitude, G′ (0.3%). G′ (0.3%) is typically measured at a stated frequency and pressure, such as at 1 Hz frequency and 100° C. The measurement can be made after pre-conditioning, e.g., after 5 min static conditioning, 10 cycles of shearing at 50% strain, and a 30 min recovery at 0.3% strain. In some embodiments, the elastomeric composite is formed from a mixture comprising at least a solid elastomer and a wet filler in which the wet filler comprises a liquid, or at least a solid elastomer and a filler and a liquid (filler and liquid charged to the mixer separately). In some embodiments, the elastomer composite is formed from a filler slurry and an elastomer or elastomer source in liquid form, e.g., elastomer solution, emulsion, latex, and the like.

In one aspect, disclosed herein are methods for processing an elastomeric composition with a screw extruder, e.g., a single screw or twin-screw extruder having a die provided at an exit end of the extruder. As used herein, the term “die” refers to a “die” or “die plate” that is provided in an end plate provided at the outlet or discharge opening of an extruder, e.g., exit end, in which slots or openings extend through the end plate forming a passageway. In some embodiments, the slots or openings are formed as holes or slots milled or drilled through the outlet or end plate of the extruder. In some embodiments, the die or die plate includes a stationary die body that does not rotate, but rather, is stationary such that the elastomeric material is extruded therethrough. In other embodiments, the die can be rotatable for cutting the composition or elastomeric material. In some embodiments, at least one edge of the slot can be a cutting edge to cut the composite into discrete pieces. In some embodiments, the die can have an associated blade (“knife” is synonymous with blade), which can be a cutting edge of the slot or can be external to the die, in which the die and/or the associated blade is rotatable.

In one aspect, the die is stationary. Accordingly, one aspect disclosed herein is a method of processing a composition, comprising: feeding the composition to a screw extruder which can be a single screw or twin-screw extruder, wherein the composition comprises at least one elastomer and at least one filler; flowing the composition through the extruder by applying a shearing force on the composition; and extruding the composition through a stationary die provided at an exit end of the single screw or the twin-screw extruder, wherein the extruding comprises: forcing the composition through at least one non-circular slot extending through a die body of the stationary die from a first face of the die body to an opposing face of the die body that opposes the first face forming a passageway such that the composition is forced across an inner surface of the at least one non-circular slot, wherein the inner surface is tapered such that a first opening at one of the first face or the opposing face is smaller than a second opening at the other of the first face or the opposing face. In another aspect, the extruding comprises: forcing the composition through at least one slot extending through a die body of the stationary die from a first face of the die body to an opposing face of the die body that opposes the first face forming a passageway such that the composition is forced across an inner surface of the at least one slot, wherein the inner surface is tapered such that a first opening at one of the first face or the opposing face is smaller than a second opening at the other of the first face or the opposing face, and wherein the first and second openings are non-concentric.

In another aspect, the die is rotatable and has an associated blade for cutting the extruded composition. Accordingly, disclosed herein is another method of processing a composition, comprising: feeding the composition to a screw extruder, wherein the composition comprises at least one elastomer and at least one filler having a filler loading of at least 20 phr in which the composition (e.g., a composite) can be substantially free of rubber chemicals and/or have a dynamic storage modulus of at least 900 kPa measured at 0.3% strain amplitude, G′ (0.3%); flowing the composition through the extruder by applying a shearing force on the composition; extruding the composition through a die provided at an exit end of the extruder, wherein the die comprises a die body having a first face and an opposing face, wherein the extruding includes traversing the composition through at least one slot extending through the die body from the first face to the opposing face that forms a passageway; and cutting the extruded composition with an associated blade of the die, wherein one or more of the die or the associated blade is rotatable.

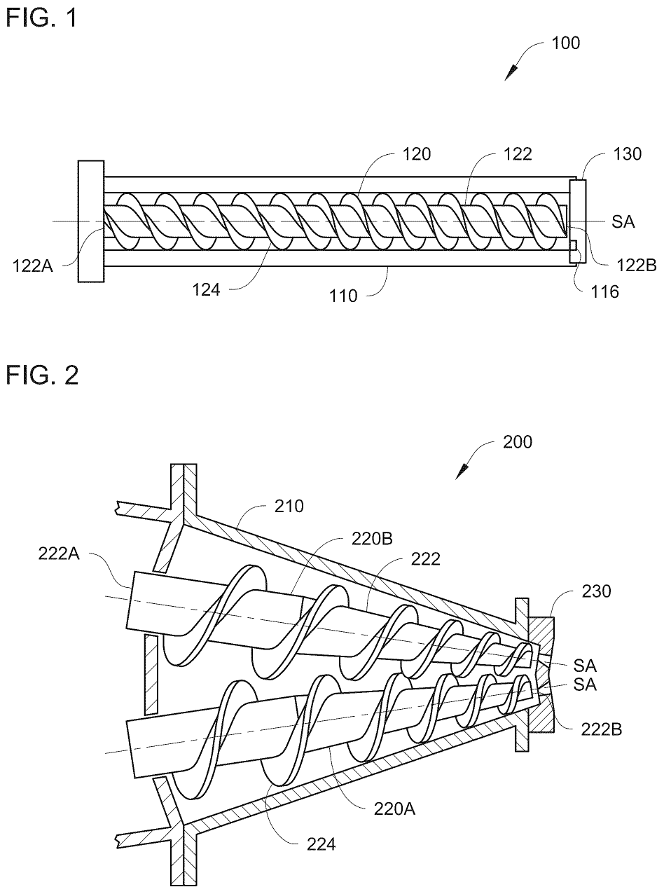

FIG. 1 is an illustrative embodiment of an apparatus for processing a composition, such as a filled elastomeric material, e.g., a composite. In some embodiments, the apparatus can be an extruder 100 for processing the elastomeric material; FIG. 1 depicts a single screw extruder. The processing can involve cutting the elastomer into discrete pieces (as opposed to long sheets or tubes), e.g., sizes of less than 500 mm and/or discrete pieces having an angle of curvature in at least one dimension (e.g., two dimensions) ranging from 50 degrees to 160 degrees (50° to 160°), in which the pieces are uniform or substantially uniform in size and/or shape. The extruder 100 can include a hopper (not shown) connected to housing 110 of the extruder 100 for feeding the composition to the extruder (continuously or intermittently), a motor (not shown) that operates one or more screws 120 to cause the composition to flow through the extruder by applying a shearing force, and a die 130 provided at an exit end of the extruder 100 for through which the elastomeric material is extruded. In some embodiments, the extruder 100 can include a reduction mechanism mounted, for example, as a drive unit for driving the one or more screws 120. In some embodiments, when the one or more screws 120 includes twin screws, conical gear(s) (not shown) can be provided to drive one or more of the screws 120, in which the driven screw(s) are rotated through meshing engagement with the conical gear(s). While FIG. 1 illustrates the extruder as an individual component for processing elastomer material, it is understood that such disclosure is not intended to be limiting. Rather, it is understood that the extruder 100 can be part of a larger mixing apparatus, which can include one or more of mixer(s), the extruder(s) 100, cutting device(s), dryer(s), baler(s), rollers, or the like. It is further understood that the extruder 100 can also be provided as a separate component/operation for the mixing apparatus or provided a part of the mixing apparatus, e.g., a single/integrated unit.

In some embodiments, each of the one or more screws 120 are provided within the housing 110 and can include a shaft 122 having a longitudinal or axial axis or screw axis “SA”, a first end 122A and a second exit end 122B, and at least one helical screw flight 124, which is depicted as a helical screw flight, provided on the shaft along the longitudinal axis from the first end 122A to the exit end 122B. In some embodiments, the shaft 122 can have a cylindrical shape with a tapered end, e.g., a circumference at the exit end 122B is narrower than at the first end 122A, and/or the at least one helical screw flight 124 can be tapered in which the at least one helical screw flight 124 can have a variable pitch and/or outer diameter that progressively decreases from the first end 122A to the exit end 122B of the shaft 122, e.g., has a maximum outer diameter nearer the first end 122A that is larger than the outer diameter of the helical screw flight at the exit end 122B. In some embodiments, the shaft 122 can have a conical shape in which the at least one helical screw flight 124 can be provided having a constant width and/or pitch. It is appreciated that while the helical screw flight 124 is discussed herein as being a single helical screw flight, it is understood that the screw can have more than one helical screw flight, e.g., screw flight in a double helix design, e.g., or a double helix at least at the exit end 122B. Moreover, when the extruder 100 includes twin screws (or more than two screws), the screws can be configured such that the helical screw flights 124 of the twin screws are in an intermeshing relationship, e.g., the helical screw flight 124 intrudes into the pitch of the other screw flight 124. As such, the one or more screws 120 are configured to cause the elastomeric material to flow from the first end 122A to the exit end 122B of the shaft 122 by applying a shearing force on the elastomeric material, when the elastomeric material is fed from the hopper, e.g., gravity feed.

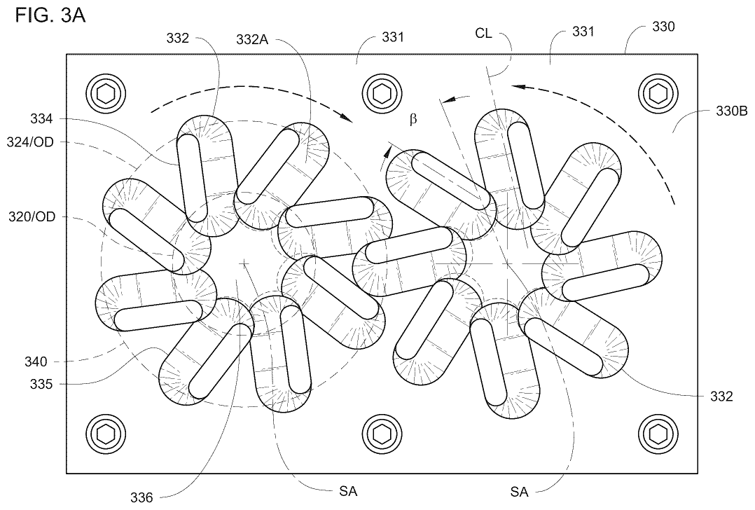

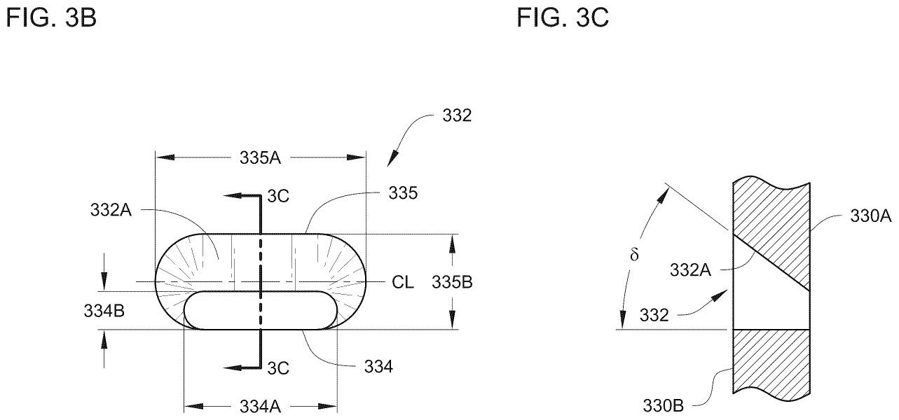

The die 130 is provided at, near, or abutting the exit end 122B of the shaft 122, e.g., in an end plate provided at the outlet or discharge opening of the extruder 100 in which slots or openings extend through a body of the die forming a passageway, such that the elastomeric material is extruded through the die 130. Various embodiments of the die 130 are discussed further below and illustrated in FIGS. 3A-5. In some embodiments, the slots or openings are formed as holes or slots (which can be any closed shape that is circular or non-circular) milled or drilled through the outlet or end plate of the extruder 100. In some embodiments, the die includes a stationary die body that does not rotate, but rather, is stationary (e.g., stationary relative to the housing 110) such that the elastomeric material is extruded therethrough. In other embodiments, the die 130 can be rotatable.

FIG. 2 is an illustrative embodiment of a twin-screw extruder. In some embodiments, the twin screws 220A, 220B are provided within the housing 210 and each can include a shaft 222 having a longitudinal axis or screw axis “SA” and a first end 222A and a second exit end 222B and at least one helical screw flight 224 provided on the shaft along the longitudinal axis from the first end 222A to the second exit end 222B. It is appreciated that while the helical screw flight 224 is discussed herein as being a single helical screw flight, it is understood that the screw having one or more helical screw flights can be used, e.g., screw flight in a double helix design. In an embodiment, the twin screws 220A, 220B are configured such that the helical screw flights 224 of the twin screws are in an intermeshing relationship, e.g., the helical screw flight 224 intrudes into the pitch of the other screw flight 224 in a counter-rotation direction. FIG. 2 further depicts the screws as that tapered towards each other. As such, the twin screws 220A, 220B are configured to cause the elastomeric material to flow from the first end 222A to the second exit end 222B of the shaft 222 by applying a shearing force on the elastomeric material, when the elastomeric material is fed from the hopper.

The die 230 can be provided at, near, or abutting the second exit end 222B of the shaft(s) 222, e.g., in an end plate provided at the outlet or discharge opening of the extruder 200, e.g., exit end, in which slots or openings extend through the end plate forming a passageway, such that the elastomeric material is extruded through the die 230. Various embodiments of the die 230 are discussed further below and illustrated in FIGS. 3A-5. In some embodiments, the slots or openings are formed as holes or slots (which can be circular or non-circular) milled or drilled through the outlet or end plate of the extruder 200. In some embodiments, the die includes a stationary die body that does not rotate, but rather, is stationary such that the elastomeric material is extruded therethrough.

Another aspect is a die provided to have a specific geometry or orientation that was unexpectedly found to cut the composite into smaller, discrete pieces, e.g., sizes of less than 500 mm and/or have an angle of curvature in at least one dimension (e.g., two dimensions) ranging from 50 degrees to 160 degrees (50° to) 160°. The pieces are uniform or substantially uniform in size and/or shape such that the pieces can be usable for subsequent processing, e.g., by the end user or customer. In some embodiments, processing and/or cutting of such composites was not previously attainable by conventional TSR and stationary knife device design(s), e.g., composites having a toughness that cannot be uniformly or substantially uniformly cut with current dies and methods, e.g., composites that are substantially free of rubber chemicals and/or having a dynamic storage modulus of at least 900 kPa measured at 0.3% strain amplitude, G′ (0.3%). G′ (0.3%). FIGS. 3A-5 illustrate various embodiments of a die, e.g., 330, 430, 530, that can be used at an exit end of a single screw or twin-screw extruder, e.g., 100, 200, for processing a composition, and in particular, extruding the elastomeric material disclosed herein.

FIGS. 3A-5 illustrate a die for a twin-screw extruder having two sets of slots, each set of slots aligned with each screw of the extruder. It would be understood, however, that a similar die could be designed for a single screw extruder with only one set of slots. As illustrated in FIGS. 3A, 3B, 3C, in an embodiment, a die 330 includes a stationary die body 331, a first face 330A of the die body 331, an opposing face 330B of the die body 331, and at least one non-circular slot 332 that extends through the die body 331 from an inlet, e.g., 334, which receives elastomeric material being extruded by the extruder, at the first face 330A to an outlet, e.g., 335, in which the elastomeric material is extruded out an exit of the extruder, at the opposing face 330B, forming a passageway.

FIG. 3A illustrates die 330 including two sets of slots 332, each set of slots being a plurality of slots. Each slot can be any closed-shape, e.g., circular or non-circular. FIG. 3A depicts a plurality of non-circular slots, the term “non-circular” referring to shapes that are not in a circle or not having a roundness close or near as being a perfect circle. The shape of the non-circular slot can be asymmetric or symmetric and can be any closed shape having a mixture of straight and curved lines, or the like. Examples of non-circular shapes include ovate or oval shapes, bean-shapes, trapezoidal, triangular, rectangular, or the like. In some embodiments, non-circular refers to elongated shapes, which can be elliptical, ovate, or oval-type shapes. Slots 332 are non-circular and have an elongated oval shape or a stadium shape in which two curved ends are joined by parallel straight sides or edges. In other embodiments, two curved ends can be joined by non-parallel straight sides or edges (e.g., petal-shaped). While an ovular or elongated ovular shapes are disclosed herein, such disclosure is not intended to be limiting. A center axis, which can be center line, “CL”, along the length of slot 332 is shown as parallel to the straight or linear edges. In some embodiments, the center line is aligned with the longest dimension of the slot opening, as shown in FIG. 3B.

In some embodiments, at least a portion of one or more of the edges of the slot 332 can define the cutting edge. In some embodiments, one or more edges (e.g., at least straight edges) of the opening of stadium-shaped slots 332 functions as a cutting surface as the extruder screw rotates and applies a shearing force of the elastomer composition against slot 332. In some embodiments, the cutting edge can be straight, rippled, or serrated.

In some embodiment, an inner surface of the slot is tapered. FIGS. 3B and 3C depict slot 332 as having an inner surface 332A with one or more walls that are tapered such that an opening 334 at first face 330A is smaller than the opening 335 at opposing face 330B. If the direction of the extruded material passes from the smaller first face 330A, through the inner surface 332A and exits the opposing face 330B, as shown in FIG. 3C, inner surface of slot 332 will have an outward taper (tapered outward). It can be appreciated that an inward taper (tapered inward) can be achieved with an opening at opposing face 330B that is smaller than the opening at first face 330A (not shown). In some embodiments, the area of the smaller opening ranges from 20% to 90% the area of the larger opening, e.g., ranging from 30% to 80%, or from 30% to 70%, or from 40% to 70% the area of the larger opening, and other ranges in between.

In some embodiments, the non-circular slot 332 can be tapered asymmetrically from the opening 334 at first face 330A to the opening 335 at opposing face 330B, e.g., asymmetric with respect to a center line “CL” of opening 335 at opposing face 330B, as depicted in FIG. 3B. In some embodiments, the asymmetric taper can be achieved by arranging the respective openings of slot 332 non-concentrically, e.g., the first opening is non-concentric with the second opening. Referring to FIG. 3B, opening 334 at first face 330A is non-concentric with opening 335 at opposing face 330B. In other embodiments, e.g., the openings of inner slot 332 are concentric and can result in a symmetric taper with respect to a center line “CL” of the non-circular slot 332 (not shown).

In some embodiment, whether the taper is symmetric or non-symmetric, a cross-section of the tapered inner surface 332A can define a taper angle, shown as δ in FIG. 3C. In some embodiments, the cross-sectional cut can be substantially parallel to the length of the passageway to reveal the taper angles, e.g., taken along center line CL of an opening or perpendicular to center line CL of the opening. In some embodiments, the taper angle ranges from 20° to 60°, e.g., from 20° to 50° or from 30° to 60° or from 30° to 50°, or other ranges in between.

In some embodiments, during rotation of the screw the material is forced against the edge of the tapered surface in which the selected taper angle and/or asymmetric taper can maintain the composition on a cutting edge of the at least one slot that substantially aligns with a direction of a vector combining tangential and radial forces imposed on the composition being extruded through the die.

In other embodiments, at least one wall of inner surface 332A of slot 332 can be substantially flat, convex, or concave. In other embodiments, at least one wall of inner surface 332A is convex or two walls are concave, or one wall is substantially flat and an opposing wall is convex or concave, or one wall can be convex and the opposing wall can be concave. In some embodiments, inner surface 332A includes at least one wall that is beveled. The beveled wall can be substantially flat, concave, or convex surface. FIG. 3C shows a substantially flat beveled wall of inner surface 332A opposing a substantially flat non-beveled wall.

Slot(s) 332 are shown in FIG. 3B as having a radial length 335A to circumferential width 335B that define the opening or hole of the opening 335 at the opposing face 330B and a radial length 334A to circumferential width 334B that define the opening or hole of the opening 334 at the first face 330A. In some embodiments, the radial length 334A, 335A to circumferential width 334A, 335B of the opening 334, 335 can be defined by a ratio of ranging from 1.1:1 to 10:1, or from 1.1:1 to 8:1, or from 1.1:1 to 6:1, or from 1.1:1 to 5:1, or from 1.1:1 to 4:1, e.g., ranging from 1.5:1 to 10:1, and most preferably ranging from 2:1 to 3:1, and ranges in between. In some embodiments, the surface area of the slot(s) 332 (or total surface area where there is more than one slot) can range from 200 mm² to 3000 mm², and preferably ranging from 300 mm² to 2500 mm².

In some embodiments, to maximize the cutting performance, each slot opening is positioned within a region of the die corresponding to the screw as defined by the outer diameter of a screw flight. FIG. 3A illustrates a circular region in die 330 corresponding to the outer diameter “OD” of a corresponding screw flight 324/OD. The respective openings of each slot 332 are positioned not to extend beyond outer diameter of screw flight 324/OD. Moreover, the openings of each slot 332 do not substantially extend into a circular region in die 330 corresponding to the outer diameter of a corresponding screw shaft 320/OD. In some embodiments, no more than 20% or no more than 10% of the opening of slot 332 extends into the circular region in die 330 corresponding to the outer diameter of a corresponding screw shaft 320/OD. By positioning the slot openings substantially between the outer diameter of screw shaft 320/OD and the outer diameter of screw flight 324/OD, without wishing to be bound by theory, it is understood that such a design of the die can minimize a change in the product flow direction of the elastomeric material, as it leaves the screw flight and flows through the slots or holes in the die, which can maintain good contact between the elastomeric material and the cutting surface to result in cutting of the product into discreet pieces having the sizes and shapes disclosed herein.

In some embodiments, the at least one non-circular slot 332 includes a plurality of non-circular slots 332. Referring to the left side of FIG. 3A, the plurality of slots 332 can be distributed equidistant from each other in the regions disclosed herein (substantially between the outer diameter of screw shaft 320/OD and the outer diameter of screw flight 324/OD). In some embodiments, each of the plurality of slots is also provided equidistant from a middle or central portion or a midpoint. FIG. 3A depicts an arrangement of a plurality of slots 332 equidistant from each other in which the outer edges of the slots establish an outline of a circular shape 340. The plurality of slots 332 can be arranged concentrically with the outer diameter of the screw flight 324/OD in which the openings of slots 332 do not extend beyond the outer diameter 324/OD. The plurality of slots 332 is also equidistant from a middle or central portion 336 or midpoint SA. However, the arrangement is not limited to a circular shape and can form other shapes (oval, square, rectangular, etc.) so long as a middle or central portion 336 or midpoint SA of the plurality of slots is substantially coaxially aligned with the corresponding screw provided in the extruder. For a twin-screw extruder, two sets of a plurality of non-circular slots are provided. In some embodiments, each set of the plurality of non-circular slots are substantially coaxially aligned with the corresponding screw provided in the extruder.

In some embodiments, each slot 332 substantially aligns with the direction of the vector combining the tangential and radial forces imposed on the material being extruded through the die 330 by the extruder. As disclosed previously, this alignment can be achieved by certain taper designs of the inner surface of slot 332. In other embodiments, such substantial alignment can be achieved with positioning of the slots. In some embodiments, the plurality of slots are positioned in a circular shape and equidistant from each other and equidistant from a middle or central portion 336, or midpoint SA, that is coaxially aligned with the corresponding screw. A center line or center axis of the slot (e.g., coinciding with the longest dimension of the slot) can be offset from an axial axis of the screw of the extruder. This is illustrated in FIG. 3A showing center line CL of slot 332, which is aligned with the longest dimension of slot 332. It can be seen that center line CL is offset from a radius that aligns with an axial axis SA of the extruder screw. FIG. 3A denotes angle β as the angle from which center line CL of slot 332 is offset from the axial axis SA. Angle β can range from 20° to 50°, e.g., from 20° to 45°, or from 20° to 40°, or from 25° to 50°, or from 25° to 45°, or from 25° to 40°, or from 30° to 50°, or from 30° to 45°, or from 30° to 40°. As such, each set of the plurality of non-circular slots 332 can be radially offset with respect to an axial axis of the screw of the extruder.

Two sets of the plurality of non-circular slots 332 can be provided for a twin-screw extruder. In some embodiments, the sets of the plurality of non-circular slots 332 overlap each other due to the intermeshing of the screw flights of the screws. In the embodiment illustrated in FIG. 3A, the die 330 has 8 slots per set, but such disclosure is not intended to be limiting. Rather, it is understood that the die 330 can include any number of slots, for example, 1 to 100 slots, and preferably between 2 to 100 slots, and most preferably between 4 to 40 slots, depending on the size of the extruder, e.g., TSR 125 or TSR 330, and/or available space on the end plate and/or to maximize the open area of the die. For example, in some embodiments, the end plate 330 can have a total area defined by the length and width of the opposing face of die body, and the plurality of non-circular slots 332 define an opening ranging from 20% to 60% of the total area of the face of the die, e.g., the holes or openings forming the passageway on the opposing face ranges from 20% to 60% of the surface area of the opposing face. In some embodiments, in which the twin screws are not parallel to each other, the die 330 may include an angle or kink between the sets of the plurality of non-circular slots, such that the die 330 can align with the end of the screw(s) of the extruder.

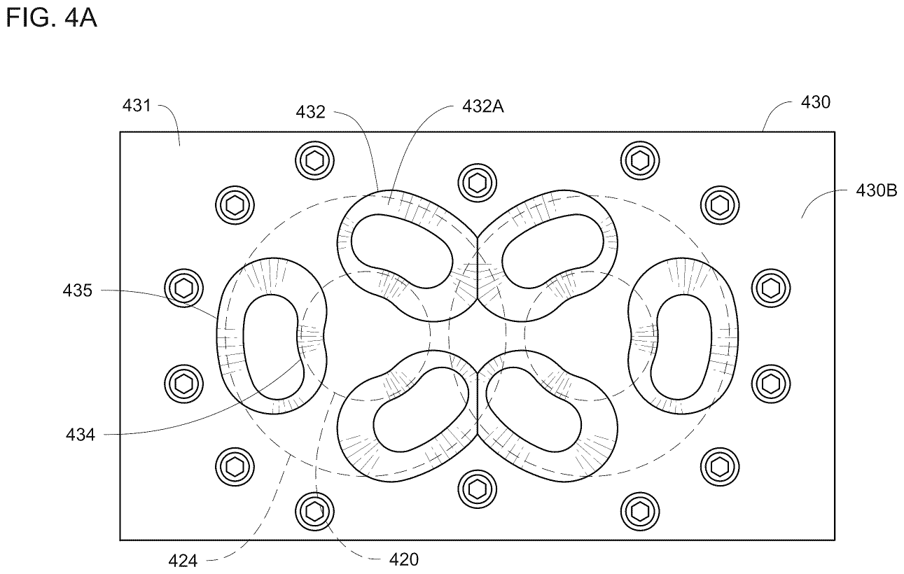

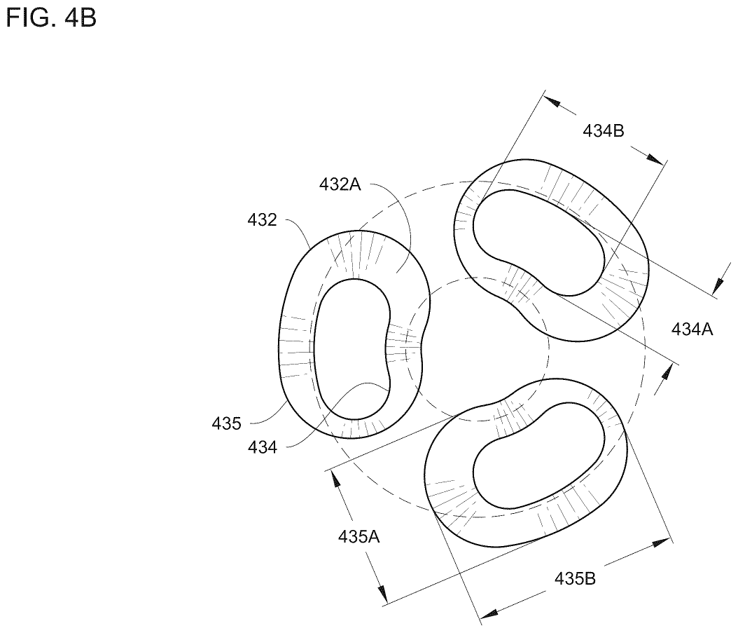

FIGS. 4A and 4B illustrate another embodiment of a die 430 including a stationary die body 431, a first face of the die body, an opposing face 430B of the die body, and at least one bean-shaped slot 432 that extends through the die body 431 from an inlet 434, e.g., which receives elastomeric material being extruded by the extruder, at the first face to an outlet 435, e.g., in which the elastomeric material is extruded to an exit of the extruder, at the opposing face 430B, forming a passageway.

As shown in FIG. 4B, which is a schematic illustration of one set of a plurality of slots with respect to one screw, in some embodiments, the plurality of bean-shaped slots 432 can be provided in a circular shape, e.g., the slots are provided concentrically around a middle or central portion, or midpoint, of the plurality of bean-shaped slots 432, in which a middle or central portion of the bean-shaped slots 432 may be concentric with the shaft of the screw 420. As such, the bean-shaped slots 432 can be provided on the die 432 that is concentric and corresponds to an outer diameter of the screw flight, e.g., a perimeter of the first opening 434 is concentric with the outer diameter of the screw flight. In some embodiments, the bean-shaped slots 432 can be provided equidistant from the adjacent bean-shaped slot, e.g., at 120° increments for three bean-shaped slots.

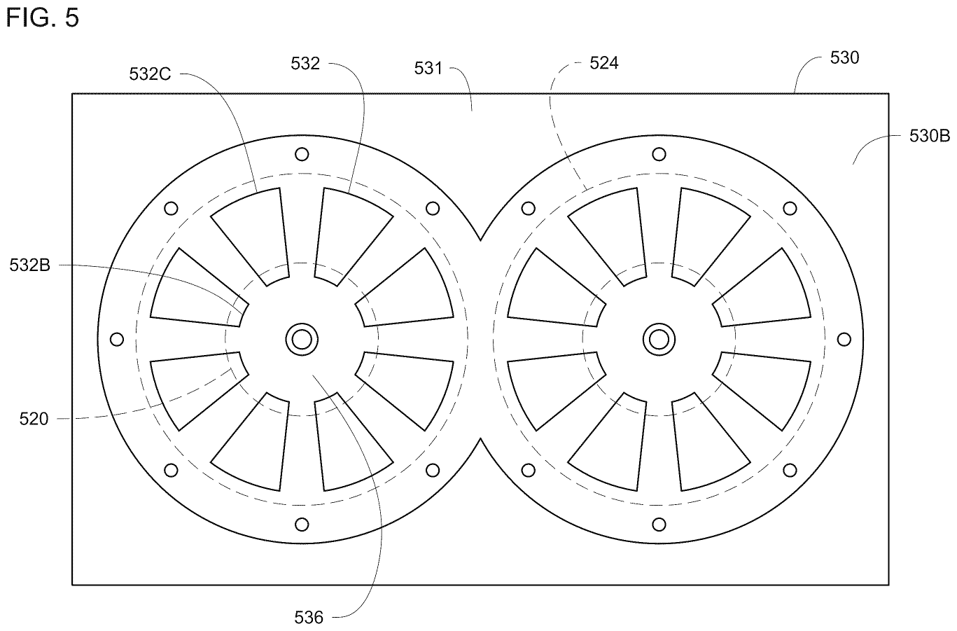

FIG. 5 illustrates another embodiment of a die 530 that includes a stationary die body 531, a first face of the die body, an opposing face 530B of the die body, and at least one slot 532 that extends through the die body 531. The slot 532 has an inner surface that is tapered such that a first opening at one of the first face or the opposing face 530B is smaller than a second opening at the other of the first face or the opposing face 530B, in which the at least one slot 532 (taper not shown).

In some embodiments, the inner surface of the slot 432, 532 of FIG. 4A, 4B or 5 is tapered through the die body 431, 531 such that the first opening, e.g., for receiving the elastomeric material being extruded, is smaller than the second opening, e.g., for extruding the elastomeric material out of the extruder. In some embodiments, the slot 432, 532 is forward tapered from the first face to the opposing face such that the first opening at the first face is smaller than the second opening at the opposing face. In some embodiments, the inner surface of the slot 432, 532 is reverse tapered from the first face to the opposing face such that the second opening at the opposing face is smaller than the first opening at the first face. The taper of the inner surface of the at least one slot 432, 532 is configured to maintain the material on a cutting edge, e.g., portion of the slot 432, 532 contacting the extruded elastomeric material. In some embodiments, die 530 can be rotatable in which the cutting edge is an associated blade.

The slot 432, 532 can be formed in different geometric shapes depending on a number of different factors, including, but not limited to, the material being extruded, the taper direction of the inner surface, the desired shape and/or size of the extrudate, or the like. In some embodiments, as illustrated in FIG. 5, the slot 532 has a trapezoidal-shape having at least one linear edge, e.g., at least a portion of the cutting edge, defining at least a portion of the first opening that substantially aligns with the direction of the vector combining the tangential and radial forces imposed on the material being extruded through the die 530 by the extruder. In some embodiments, the slot 532 extends in a radial direction, such that a first end 532B of the slot 532, which is closer to a center of a plurality of slots, has a smaller width (in a circumferential direction) than a width of a second end 532C of the slot 532 that opposes the first end, e.g., closest to the diameter of the screw flight 524, e.g., the width of the second end 532C is wider than the width of the first end 532B (in a radial direction). In some embodiments, the at least one linear edge includes rippled or serrated edges that form at least a portion of the linear edge.

In some embodiments, the at least one non-circular slot 432, 532 includes a plurality of non-circular slots 432, 532. Referring to the left side of FIG. 5, the slots can be provided concentrically extending from a middle or central portion 536, e.g., between the outer diameter of the screw of the shaft 520 and the diameter of the screw flight 524. In some embodiments, each of the plurality of slots is provided equidistant from the middle or central portion 536. For a twin-screw extruder, two sets of a plurality of non-circular slots are provided. In some embodiments, each set of the plurality of non-circular slots are substantially coaxially aligned with the corresponding screw provided in the extruder.

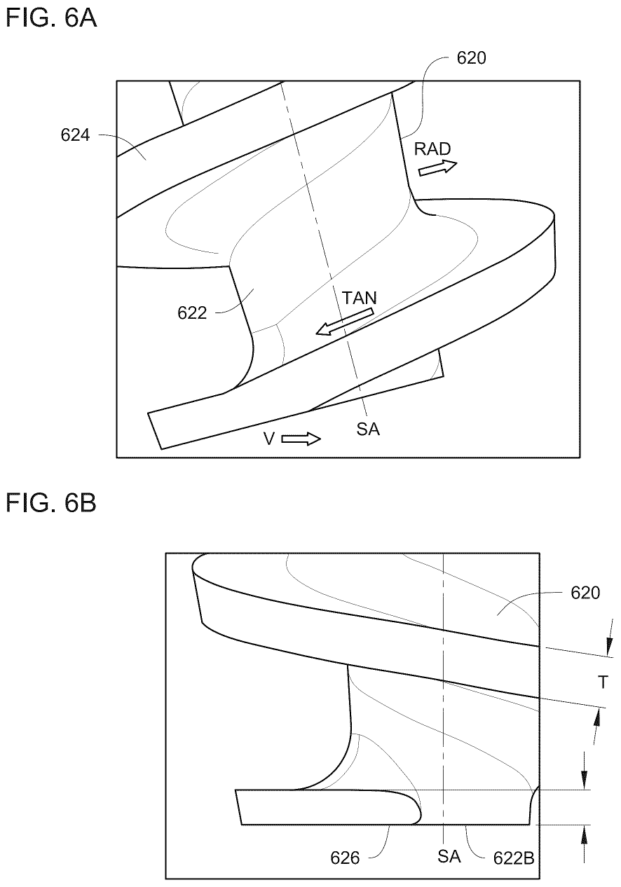

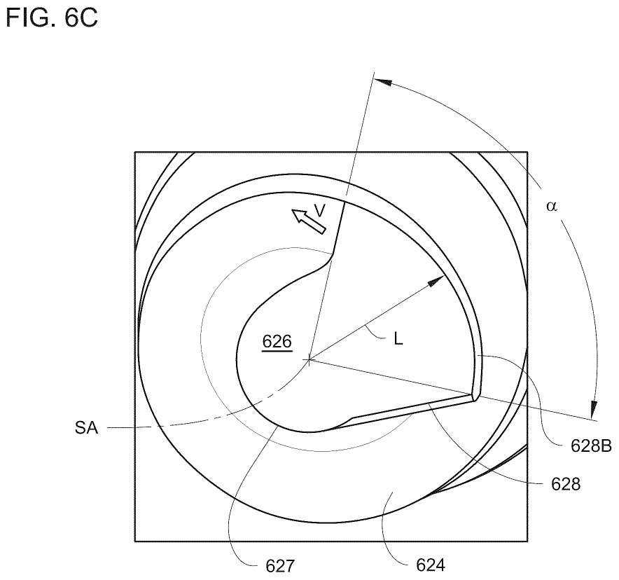

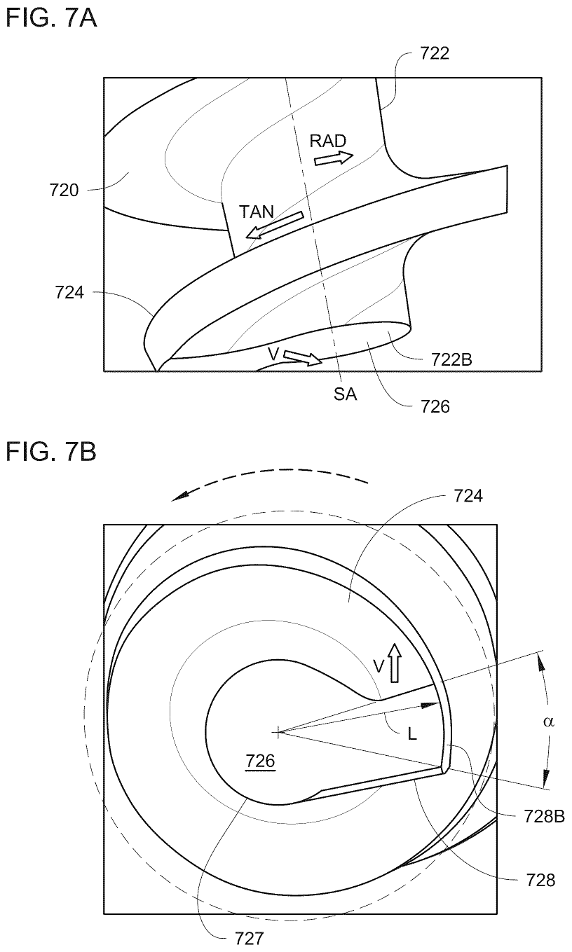

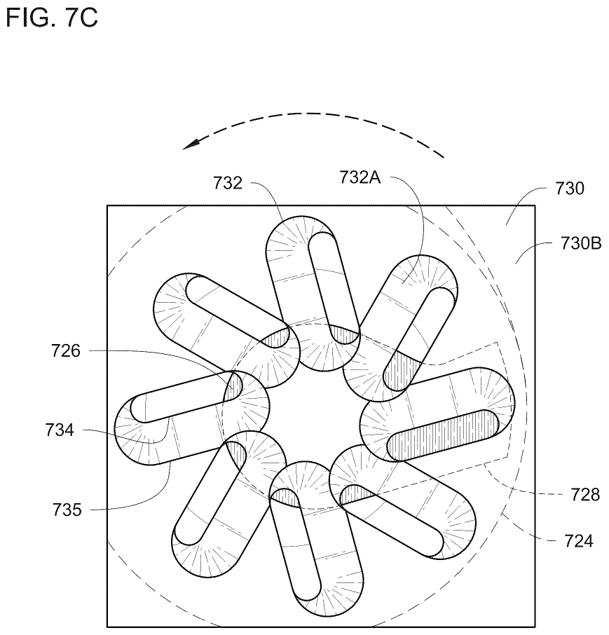

In some embodiments, as illustrated in FIGS. 6A-7C below, the one or more screws can be specifically designed to engage and/or be aligned with the die 130, 230, 330, 430, 530. For example, in some embodiments, the one or more screws can be configured such that at the second exit end of the shaft, the shaft and the at least one helical screw flight together form an end portion having a flat face, e.g., for processing the elastomeric material through the die.

As illustrated in FIGS. 6A, 6B, 6C, the at least one screw 620 is specifically designed to engage and/or be aligned with the die 130, 230, 330, 430, 530. The screw 620 can be configured such that at the second exit end 622B of the shaft 622, the shaft 622 and the at least one helical screw flight 624 together form an end portion 626 having a flat face, e.g., for processing the elastomeric material through the die. The screw 620 is configured, designed, or otherwise provided such that as the screw 620 rotates, e.g., in a counter-clockwise rotation, the end portion 626 imposes tangential “TAN” and radial “RAD” forces on the elastomeric material, such that the elastomeric material is forced into or extruded through the slot(s) of the die in a vector direction “V”. While a single vector that is the combination of the tangential and radial forces is shown in the Figures, it should be appreciated that elastomeric material is forced into or extruded in a respective vector direction at each slot along the die, e.g., in a different vector direction at each of the slot(s).

In some embodiments, the end portion 626 can have a surface area ranging from 20% to 70% of an area defined by an outer diameter of the at least one helical screw flight 624, and in some embodiments, ranging from 20% to 60%, or from 20% to 50%, or from 20% to 40%, or from 20% to 30%, or from 25% to 70% or from 25% to 60% or from 25% to 50%, or from 25% to 40%, or from 25% to 35%, or from 30% to 70%, or from 30% to 60%, or from 30% to 50%, or from 40% to 50% of the area defined by the outer diameter of the at least one helical screw flight, e.g., helical screw flight 624. In some embodiments, the outer diameter of the at least one helical screw flight 624 can be the area defined by the maximum outer diameter of the at least one helical screw flight 624, e.g., the diameter of the largest flight, or the outer diameter of the at least one helical screw flight at the second exit end 622B, e.g., the diameter of the smallest flight.

That is, in some embodiments, the end portion 626 of the screw 620 is modified to be used with the die 130, 230, 330, 430, 530. In some embodiments, the screw 620 can be shortened to form the end portion 626 with the flat face by truncating the end of the screw 620 to have a specific length, e.g., for formation of the end portion having the flat face for engaging and/or aligning with the die 130, 230, 330, 430, 530. As such, the end portion 626 of the screw 620 has a clearance distance between the end portion 626 and the die 130, 230, 330, 430, 530 ranging from 0.5 mm to 5.0 mm, e.g., from 0.5 mm to 3.0 mm or from 0.5 mm to 2.0 mm, preferably from 0.8 mm to 2.0 mm, and most preferably from 1.0 mm to 2.0 mm or from 1.5 mm to 2.0 mm, and ranges in between.

As illustrated in FIG. 6B, in some embodiments, a thickness “T” of the end portion having the flat face (or the wedge portion 628) ranges from 5 mm to 15 mm, preferably from 7.5 mm to 15 mm, and most preferably from 7.5 mm to 10 mm, while a thickness “Tr” of the screw flight can range from 10 mm to 20 mm.

As further illustrated in FIG. 6C, in some embodiments, the flat face of the end portion 626 includes a circular portion 627 and a wedge portion 628. The wedge portion 628 is at least partially formed by a portion of the at least one helical screw flight 624, such that the wedge portion 628 is configured to align with the at least one non-circular slot of the die 130, 230, 330, 430, 530. In some embodiments, the wedge portion 628 can include an outer edge 628B formed by the at least one helical screw flight such that the outer edge 628B and the wedge portion defines a sector having an angle α ranging from 20° to 100°, and preferably, ranging from 20° to 50°. In some embodiments, a length “L” of the wedge portion 628 to the screw axis “SA” of the circular portion 627 is at least 70% of the radius formed by a widest length of the at least one helical screw flight 624, e.g., radius of the largest flight of the helical screw flight 624. In some embodiments, the end portion 626 of the shaft 622 and helical screw flight 624 can be provided by truncating the end of the screw 620.

In some of the embodiments, the wedge portion 628 of the flat face of the screw 620 can be configured such that the wedge portion 628 has a surface area ranging from 0.9 to 3 times, or ranging from 0.9 to 2 times, and preferably ranging from 0.9 to 1.5 times, an area of at least one non-circular slot of the die 130, 230, 330, 430, 530. As such, at least a portion of the flat face, such as, the wedge portion 628, is configured to align with at least one non-circular slot of the die such that the portion of the flat face covers or overlaps an entirety of the at least one non-circular slot of the die with each rotation of the screw 620, which was surprisingly found to contribute to the cutting of the elastomeric material such that the extruded elastomeric material has a length that is no more than 500 mm, and preferably ranging from 50 mm to 150 mm.

FIGS. 7A, 7B, 7C illustrate another embodiment of an end portion of at least one screw 720, which can be used in any of the embodiments of the extruders, e.g., 100 or 200, as discussed herein and can have the same or similar features as the screw 620, discussed above. As illustrated in FIG. 7B, in some embodiments, the flat face of the end portion 726 includes a circular portion 727 and a wedge portion 728 that is narrower than the embodiment of FIGS. 6A, 6B, and 6C. As depicted in FIG. 7C, the wedge portion 728 covers or overlaps at least 90% of the opening area of the non-circular slot 732. In some of the embodiments, the wedge portion 728 of the flat face of the screw 720 can be configured such that the wedge portion 728 has a surface area that ranges from 0.9 to 1.5 times, an area of the non-circular slot 732 of the die 730.

While the screw 620, 720 has been discussed above with respect to a single screw, such disclosure is not intended to be limited. Rather, it is understood that the at least one screw 620, 720 can be used in a twin-screw extruder, in which the twin screws taper towards each other. The twin-screw extruder can be configured such that the screws 620, 720, when provided as a twin screw, are provided as counter-rotating intermeshing screws within the housing that taper towards. FIG. 7A show screw 720, as part of twin screws, apply tangential (“TAN”) and radial (“RAD”) forces on the elastomeric material to cause the elastomeric material to flow in a vector direction (“V”) that is combination of the tangential and radial forces out of the die 130, 230, 330, 430, 530. In some embodiments, a minimum clearance C between the second exit ends of the twin screws 620, 720, e.g., the portion of the helical screw flights 624, 724 that intermesh to force or extrude the elastomeric material through the die, e.g., 130, 230, 330, 430, 530, ranges from 10 mm to 25 mm, preferably ranges from 15 mm to 22 mm.

As such, the extruder, e.g., 100 or 200, is configured to extrude elastomeric compositions. In some embodiments, the extruder is configured to have a rotation speed of the screws ranging from 5 rpm to 50 rpm, and preferably ranging from 10 rpm to 35 rpm. In some embodiments, the extruder is configured to maintain one or more of the following: a temperature of a main body, e.g., chamber, of the extruder housing the screws and the screws ranging from 55° C. to 90° C.; a center of the end plate temperature ranging from 100° C. to 150° C.; or a temperature of the elastomeric material ranging from 100 to 140° C. As such, the extruder is configured to provide an exit velocity of the elastomeric material ranging from 0.05 m/min to 30 m/min., e.g., from 0.1 m/min to 30 m/min, and preferably ranging from 0.05 m/min. to 16 m/min., and most preferably ranging from 0.1 m/min. to 16 m/min.

In some embodiments, the extruder is configured to extrude elastomeric material (extrudate) cut into discrete pieces. In some embodiments, the extrudate has a has a length no more than 500 mm. “Length” refers to the longest dimension of an extrudate that can be formed with a straight line, whereas the width is the longest dimension perpendicular to the length. In some embodiments, the extrudate has a length of no more than 500 mm, e.g., no more than 400 mm, or no more than 300 mm, or no more than 250 mm, or no more than about 200 mm, no more than about 150 mm, e.g., ranging from 20 mm to 500 mm, from 20 mm to 400 mm, from 20 mm to 300 mm, from 20 mm to 250 mm, from 20 mm to 200 mm, or from 20 mm to 150. Other ranges in between are also contemplated.

In some embodiments, the extrudate has an aspect ratio of the length to the width ranging from 1.5:1 to 5:1, e.g., ranging from 1.5:1 to 4:1, or ranging from 1.5:1 to 3:1, or ranging from 1.5:1 to 2:1, or ranging from 2:1 to 5:1, or ranging from 2.5:1 to 5:1, or ranging from 3:1 to 5:1. With such aspect ratios, the extrudate can have a width ranging from 20 mm to 300 mm, e.g., from 20 mm to 200 mm, from 20 mm to 150 mm, from 20 mm to 100 mm, or from 20 mm to 75 mm, or from 20 mm to 50 mm.

In some embodiments, the extrudate has thickness ranging from 2 mm to 25 mm, e.g., a thickness ranging from 3 mm to 25 mm, or from 5 mm to 25 mm, or from 7 mm to 25 mm, or from 10 mm to 25 mm, or from 2 mm to 20 mm, or from 3 mm to 20 mm, or from 5 mm to 20 mm, or from 7 mm to 20 mm, or from 10 mm to 20 mm, or from 2 mm to 15 mm, or from 3 mm to 15 mm, or from 5 mm to 15 mm, or from 7 mm to 15 mm, or from 10 mm to 15 mm, or from 2 mm to 10 mm, or from 3 mm to 10 mm, or from 5 mm to 10 mm.

In some embodiments, the extruder is configured to provide an extrudate having an area ranging from 0.0005 to 0.01 m², e.g., from 0.0005 to 0.007 m².

In some embodiments, the extruder is configured to extrude elastomeric material into discrete pieces in which the extrudate has a curved shape. In some embodiments, the extrudate has an angle of curvature (degree of curvature) in at least one dimension ranging from 50° to 160°, or from 50° to 150°, or from 60° to 160°, or from 60° to 150°, or from 70° to 160°, or from 70° to 150°. In other embodiments, the extrudate has an angle of curvature in two dimensions ranging from 50° to 160° or other ranges disclosed herein. The angle of curvature can be determined from a main body portion of the extrudate, e.g., the portion of the extrudate having a thickness of at least 2 mm, or at least 3 mm, or at least 5 mm, or at least 7 mm, or at least 10 mm up to 25 mm or up to 20 mm. The main body portion would not include thin wisps of material formed, e.g., at the periphery of the extrudate. The main body portion could be the entire extrudate or could define a perimeter within an area of the extrudate having a minimum thickness of at least 2 mm, or other dimensions disclosed herein. Thus, in some embodiments, the extrudate has a main body portion having an angle of curvature in at least one dimension ranging from 50° to 160°.

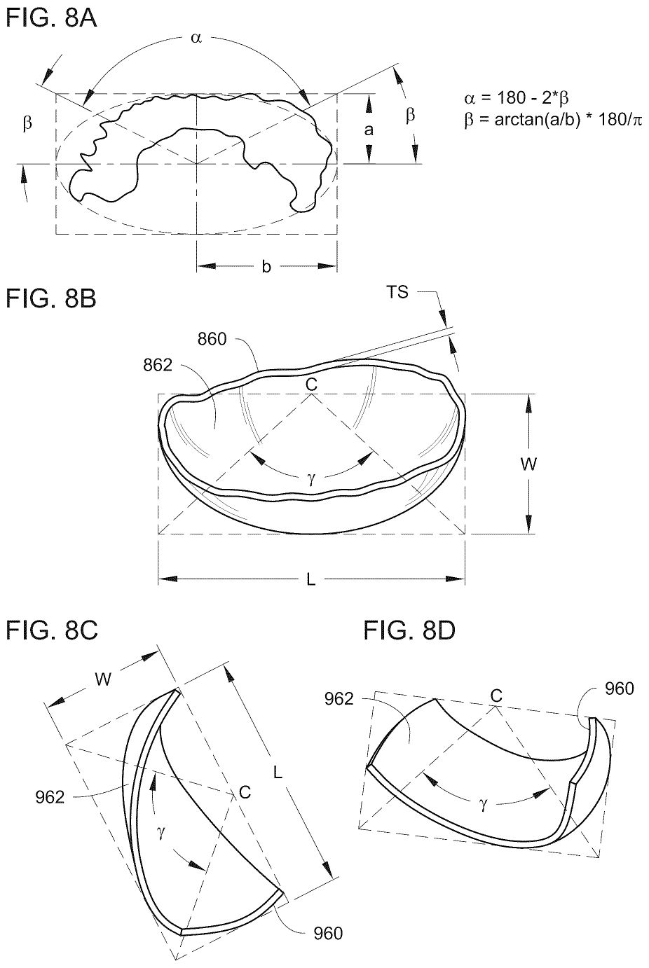

In some embodiments, the angle of curvature can be defined as a central angle of a perimeter defining the main body portion in which the angle of curvature in at least one dimension ranges from 50° to 160°. For example, the angle of curvature can be determined with imaging software, such as ImageJ software available from https://imagej.net/. As shown in FIG. 8A, an outline of the extrudate can be fitted to an ellipse from which x- and y-axes (major and minor axes) can be determined by the software. The x-axis is aligned along the longest straight-line dimension of the extrudate (“length” of the extrudate, as previously defined herein) whereas the y-axis is aligned with the width of the ellipse. As shown in FIG. 8A, “a” denotes half the width and “b” denotes half the length. The angle of curvature, α, can be determined from the equation: α=180°−2β where B=arctan (a/b)*180/π.

In some embodiments, the angle of curvature can be in two dimensions and can result in various geometric shapes, such as a scoop. For example, the extrudate can have a substantially planar main body portion with another main body portion having one an angle of curvature in at least one dimension ranges from 50° to 160° (e.g., curves, twists, or the like), such that the elastomeric extrudate as a whole is not flat in any dimension. It is understood that the term “substantially planar” refers to the main body portion that is considered non-curved, i.e., having an angle of curvature less than 50°.

In some embodiments, the extrudate has a length of no more than 500 mm, or other ranges disclosed herein, e.g., ranging from 20 mm to 150 mm, and (a main body portion having) an angle of curvature in at least one dimension ranging from 50° to 160°, or other ranges disclosed herein, and and/or an aspect ratio of the length to the width ranging from 1.5:1 to 5:1, or other ranges disclosed herein, and/or a thickness ranging from 2 mm to 25 mm, or other ranges disclosed herein. Other features disclosed herein are also contemplated.

In some embodiments, the elastomeric extrudate having (a main body portion with) a curved shape in at least one dimension can have an irregular shape, e.g., a shape which is not a pellet, cylindrical, flat sheet, or the like. Without wishing to be bound by theory, the shape of the elastomeric extrudate can be due to the elastomeric material being subjected to more deformation at a periphery thereof than the center, e.g., due in part from the configuration of the screw and/or die, such that the regions of high deformation are subject to some degree of permanent “set” due to the rubber chain being less entangled.

FIGS. 8B-8D show illustrative embodiments of an extrudate 860, 960, e.g., an elastomeric material being extruded from a screw extruder as disclosed herein. In some embodiments, the elastomeric material is formed by extruding the elastomeric material through a single screw or twin-screw extruder, as discussed above. In some embodiments, the elastomeric material is specially processed through an extruder having one or more of the following features:

As illustrated in FIG. 8B, in one embodiment of the elastomeric extrudate 860, the elastomeric extrude 860 has an irregular shape, e.g., a shape which is not a pellet, cylindrical, flat sheet, or the like, in which a main body portion has an angle of curvature y in at least two dimensions ranging from 50° to 160°. The main body portion 862 further includes a length, a width, and a thickness. As such, the elastomeric extrudate 860 has a “scoop” shape, in which the main body portion 860 has an angle of curvature in at least the length and width directions.

In some embodiments, the length of the main body portion 862 is no more than 500 mm, and preferably, ranges from 20 to 150 mm, and more preferably ranges from 50 and 150 mm. In some embodiments, the length and/or width is no smaller than 20 mm. In some embodiments, the main body portion 862 can have an aspect ratio of the length to the width of the main body portion ranges from 1.5:1 to 5:1. As such, the main body portion 862 can have a surface area ranging from 0.0005 to 0.01 m², and preferably ranging from 0.0005 to 0.007 m². In some embodiments, the main body portion 862 has a thickness “TS” ranging from 2 mm to 25 mm, e.g., ranging from 2 mm to 20 mm, and preferably a thickness ranging from 2 mm to 20 mm. In some embodiments, the thickness of the main body portion 862 is uniform or substantially uniform, e.g., has the same or substantially the same thickness throughout the main body portion 862.

FIGS. 8C and 8D illustrate an embodiment of the elastomeric extrudate 960 in which the elastomeric extrudate 960 has a main body portion 962 has a length L and width W and an angle of curvature y in at least two dimensions ranging from 50° to 160°. These parameters can be provided via the extrusion process (and/or based on the properties of the elastomer material being extruded). In some embodiments, the angle of curvature y can be defined as a central angle of the main body portion delimiting a perimeter of the main body portion 962 in which the angle of curvature in at least two dimensions ranges from 50° to 160°. Elastomeric extrudate 960 is depicted as having a “scoop” shape, in which the main body portion 960 has an angle of curvature in at least the length or width directions and is not planar as would be normally understood. FIGS. 8C and 8D depict an extrudate in which the main body portion 962 is equivalent to the whole extrudate. In other embodiments, an extrudate can have portions at the edge of minimal thickness, e.g., a thickness of less than 2 mm or less than 3 mm or less than 5 mm, which would not be considered a main body portion.

In some embodiments, the main body portion 962 includes a twisted portion. In some embodiments, the main body portion 962 can include at least one curved portion on at least a portion of the main body portion 962. The at least one curved portion and/or twisted portion can have an angle of curvature in at least one dimension, e.g., along the length and/or the width, ranging from 50° to 160°. In some embodiments, the length and/or the width of the main body portion 962 is as described for extrudate 862.

Also provided herein is a plurality of extrudates. In some embodiments, the plurality of extrudates has a uniform or substantially uniform size distribution, e.g., at least 75% of a plurality of extrudates has a length of no more than 500 mm (or other ranges disclosed herein, e.g., ranging from 20 mm to 150 mm, and at least 75% of the plurality of extrudates has (a main body portion having) an angle of curvature in at least one dimension ranging from 50° to 160°. Optionally, at least 75% of the plurality of extrudates has an aspect ratio of the length to the width ranging from 1.5:1 to 5:1, or other ranges disclosed herein, and/or a thickness ranging from 2 mm to 25 mm, or other ranges disclosed herein.

In other embodiments, at least 80% of the plurality of extrudates has a length of no more than 500 mm, e.g., at least 85%, or at least 90%, or at least 95% of the plurality of extrudates has a length of no more than 500 mm, or other ranges disclosed herein, e.g., ranging from 20 mm to 150 mm. In yet other embodiments, from 75% to 100%, or from 75% to 99%, or from 80% to 100%, or from 80% to 99%, or from 85% to 100%, or from 85% to 99%, or from 90% to 100%, or from 90% to 99% or from 95% to 100% or from 95% to 99% of the plurality of extrudates has a length of no more than 500 mm, or other ranges disclosed herein, e.g., ranging from 20 mm to 150 mm.

In some embodiments, at least 75% of a plurality of extrudates has a thickness ranging from 2 mm to 25 mm, e.g., a thickness ranging from 3 mm to 25 mm, or from 5 mm to 25 mm, or from 7 mm to 25 mm, or from 10 mm to 25 mm, or from 2 mm to 20 mm, or from 3 mm to 20 mm, or from 5 mm to 20 mm, or from 7 mm to 20 mm, or from 10 mm to 20 mm, and/or an aspect ratio of the length to the width ranging from 1.5:1 to 5:1, e.g., ranging from 1.5:1 to 4:1, or ranging from 1.5:1 to 3:1, or ranging from 1.5:1 to 2:1, or ranging from 2:1 to 5:1, or ranging from 2.5:1 to 5:1, or ranging from 3:1 to 5:1. In other embodiments, at least 80% of the plurality of extrudates has these disclosed thicknesses and/or aspect ratios, such as a thickness ranging from 2 mm to 25 mm and/or an aspect ratio of the length to the width ranging from 1.5:1 to 5:1, e.g., at least 85%, or at least 90%, or at least 95% of the plurality of extrudates has a thickness ranging from 2 mm to 25 mm, and/or an aspect ratio of the length to the width ranging from 1.5:1 to 5:1, or other ranges disclosed herein. In yet other embodiments, from 75% to 100%, or from 75% to 99%, or from 80% to 100%, or from 80% to 99%, or from 85% to 100%, or from 85% to 99%, or from 90% to 100%, or from 90% to 99% or from 95% to 100% or from 95% to 99% of the plurality of extrudates has a thickness ranging from 2 mm to 25 mm and/or an aspect ratio of the length to the width ranging from 1.5:1 to 5:1, or other ranges disclosed herein.

In some embodiments, at least 80% of a plurality of extrudates has an angle of curvature in at least one dimension ranging from 50° to 160°, e.g., at least 85%, or at least 90%, or at least 95% of the plurality of extrudates has an angle of curvature in at least one dimension ranging from 50° to 160°. In yet other embodiments, from 75% to 100%, or from 75% to 99%, or from 80% to 100%, or from 80% to 99%, or from 85% to 100%, or from 85% to 99%, or from 90% to 100%, or from 90% to 99% or from 95% to 100% or from 95% to 99% of the plurality of extrudates has an angle of curvature in at least one dimension ranging from 50° to 160°.

In one aspect, the extrudate or plurality of extrudates can be useful in the formation of bales. It is known to supply rubber masterbatch in solid bales. If the solid form is used for mixing or compounding, the high density and/or toughness of the material will typically result in long batch times. The bales could be reduced in size before mixing (e.g. using a bale granulator), but it would be necessary to retrofit such equipment to an existing mixing line. Moreover, the close packing of granulated pieces can still produce an agglomerate having a high bulk density and thus, minimal, benefit over the solid form. Alternatively, the masterbatch could be supplied in sheet form. However, depending on the product, the additional energy required to convert the product into a usable sheet form can be detrimental to the eventual product performance. In addition, such sheet (or granulated form) normally has to be coated in anti-tack, which is not preferred in some applications.

There have been previous attempts to make a more processable bale of rubber masterbatch. For example, a “loose bale” can be created by first forming the master-batch into small pieces and then compressing the pieces together in a rubber baler. The pieces of master-batch can be formed by converting the product in a narrow strip, 40-60 mm wide, before cutting it into strips at high speed. Alternatively, the master-batch can be processed in a single screw extruder fitted with a pelletizing head. These processes typically make pieces that are less than 10 mm in their shortest dimension. Such methods typically make bales that contain up to 20% void volume, although bales of up to 40% void volume have been disclosed (see U.S. Pat. No. 7,341,142). Depending on the effective viscosity of the master-batch, the mixing of such bales can still result in an extended batch time if processed whole, even if the individual pieces were coated in anti-tack, prior to baling.

Due to the extrudates having an angle of curvature, as disclosed herein, a bale comprising such extrudates will not pack as efficiently as a bale containing extrudates having a regular shape. In some embodiments, a bale comprising the extrudates can have a void volume ranging from 50% to 90%, or a void volume fraction of at least 0.5 or ranging from 0.5 to 0.9. This is due, at least in part, to the extrudate having an angle of curvature in at least one dimension, and preferably in at least two dimensions. This increased void volume or void fraction can facilitate rapid compounding as the extrudates in the bale can be conveyed directly to mixing or compounding or roll milling equipment without additional processing, compared to a bale having a lower void volume or void fraction, e.g., a bale that is more efficiently or tightly packed.

“Void volume” refers to the percent volume of voids, that is, air gaps, spaces, or interstices, in a bale or occupied portion of a container of elastomer composite pieces or extrudates. In the case where the elastomer composite pieces are baled, the void volume can be determined by subtracting the volume of the elastomer composite pieces (which can be calculated from the total weight of the pieces and the material density, as weight per unit volume) from the total volume of the bale. The void fraction is obtained by dividing the total volume of the bale; void volume is obtained by multiplying the void fraction by 100.

The shape of the extrudates avoids close packing of the extrudates in a bale, which would facilitate rapid cooling. This form is optimal for feeding downstream equipment, such as a Banbury mixer or roll mill. The bale can be quickly ingested by a mixer or roll mill due to its decreased bulk density; for a 0.5 void volume fraction, the bulk density is no more than 0.5 g/cm³ or no more than 0.6 cm³.

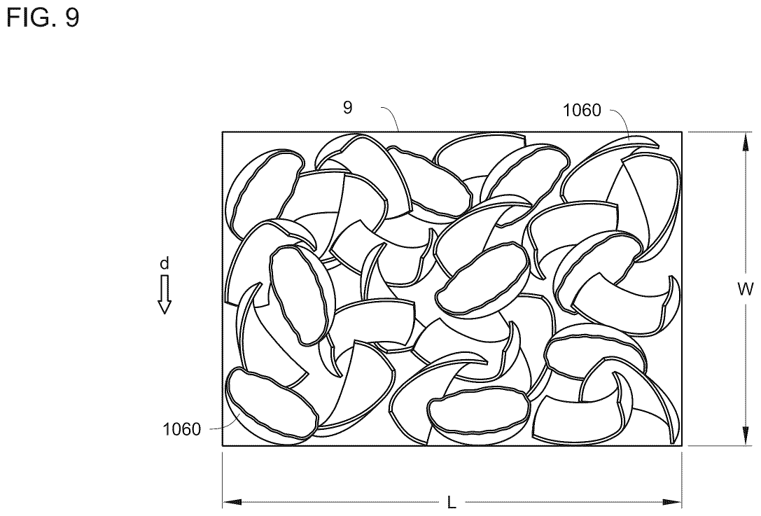

FIG. 9 depicts a bale 970 of elastomeric extrudates 1060, which can have the same or similar features as any of the extrudes 860, 960 discussed above, and can be combined for further processing, e.g., by downstream customers to form the final product. In some embodiments, the one or more elastomeric extrudates 1060 can include a plurality of elastomeric extrudates that can be combined in various forms, including, but not limited to an agglomerate of pieces, such as, a bale, in a bag, or the like. In some embodiments, the elastomeric extrudate can have a product density ranging from 800 kg/m³ to 1,500 kg/m³. In some embodiments, the plurality of elastomeric extrudates 1060 can be formed into a bale 970. In some embodiments, the bale 970 can have a shape that is substantially rectangular, but such disclosure is not intended to be limiting. Rather, the shape of the bale 970 can be cylindrical, parallelepiped, or the like. In some embodiments, the bale 970 can have any dimension known in the art. As an example, the bale 970 can have a width ranging from 10 in. to 15 in. (0.254 m to 0.381 m), and/or a length ranging from 25 in. to 30 in. (0.635 m to 0.762 m), and/or a depth ranging from 3 in. to 10 in. (0.0762 m to 0.254 m). Other dimensions are readily apparent to one skilled in the art.

In some embodiments, the bale 970, is formed of a plurality of elastomeric extrudates 1060 in which at least 75% of the plurality of elastomeric extrudates has a length of no more than 500 mm and at least 75% of the plurality of elastomeric extrudates has (a main body portion having) an angle of curvature in at least one dimension ranging from 50° to 160°, and other dimensions and ranges disclosed herein.

In some embodiments, the extrudate can be formed by processing a composition with an extruder having a die plate with at least one non-circular slot extending through a die body of the stationary die from a first face of the die body to an opposing face of the die body that opposes the first face forming a passageway such that the composition is forced across an inner surface of the at least one non-circular slot, wherein the inner surface is tapered such that a first opening at one of the first face or the opposing face is smaller than a second opening at the other of the first face or the opposing face. In some embodiments, the at least one slot is configured to substantially align with a direction of a vector combining tangential and radial forces on the composition being extruded through the die from the extruder.

In some embodiments, the bale can be produced by filling a bag provided in a bale form with the plurality of elastomeric extrudates as disclosed herein. In some embodiments, the bag is placed in a container having a shape in which the bale will take the shape of the container. In some embodiments, the bale is a “loose bale” in which minimal or no pressure is applied by a ram or similar device for the purpose of fitting the plurality of extrudates into the container.

The elastomeric composition, whether it be a composite or vulcanizate, resulting in the extrudate comprises at least one elastomer and at least one filler having a loading of at least 20 phr. Composites can be considered an uncured mixture of filler(s) and elastomer(s), optionally with one or more additives, and can be considered a mixture or masterbatch. The composite can be considered an intermediate product that can be used in subsequent rubber compounding and one or more vulcanization processes to form cured compounds or vulcanizates.

Exemplary elastomers include natural rubber (NR), functionalized natural rubber (e.g., epoxidized natural rubber (ENR)), synthetic elastomers such as styrene-butadiene rubber (SBR, e.g., solution SBR (SSBR), emulsion SBR (ESBR), or oil-extended SSBR (OESSBR)), functionalized styrene-butadiene rubber, polybutadiene rubber (BR), functionalized polybutadiene rubber, polyisoprene rubber (IR), ethylene-propylene rubber (EPDM), isobutylene-based elastomers (e.g., butyl rubber), halogenated butyl rubber (e.g., chlorinated butyl rubber (CIIR), brominated butyl rubber (BIIR)), polychloroprene rubber (CR), nitrile rubbers (NBR), hydrogenated nitrile rubber (HNBR), fluoroelastomers, perfluoroelastomers, and silicone rubber. As an option, the elastomer can be selected from at least one of natural rubber, styrene-butadiene rubber, and polybutadiene rubber, including blends thereof.

Other synthetic polymers that can be used in the present methods (whether alone or as blends) include hydrogenated SBR, and thermoplastic block copolymers (e.g., such as those that are recyclable). Synthetic polymers include copolymers of ethylene, propylene, styrene, butadiene and isoprene. Other synthetic elastomers include those synthesized with metallocene chemistry in which the metal is selected from Ce, Pr, Nd, Sm, Gd, Tb, Dy, Ho, Tm, Yb, Lu, Co, Ni, and Ti. Polymers made from bio-based monomers can also be used, such as monomers containing modern carbon as defined by ASTM D6866, e.g., polymers made from bio-based styrene monomers disclosed in U.S. Pat. No. 9,868,853, the disclosure of which is incorporated by reference herein, or polymers made from bio-based monomers such as butadiene, isoprene, ethylene, propylene, farnesene, and comonomers thereof.

Other exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like.

Other applicable elastomers that can be used in the presently disclosed methods are disclosed in PCT Publ. No. WO 2020/247663, the disclosure of which is incorporated by reference herein.

If two or more elastomers are used, the two or more elastomers can be charged into the mixer as a blend at the same time (as one charge or two or more charges) or the elastomers can be added separately in any sequence and amount. For example, the elastomer can comprise natural rubber blended with one or more of the elastomers disclosed herein, e.g., butadiene rubber and/or styrene-butadiene rubber, or SBR blended with BR, etc. For instance, the additional elastomer can be added separately to the mixer and the natural rubber can be added separately to the mixer.

The elastomer can be or include natural rubber. If the elastomer is a blend, it can include at least 50 wt. % or at least 70 wt. % or at least 90 wt. % natural rubber. The blend can further comprise synthetic elastomers such as one or more of styrene-butadiene rubber, functionalized styrene-butadiene rubber, and polybutadiene rubber, and/or any other elastomers disclosed herein.

The natural rubber may also be chemically modified in some manner. For example, it may be treated to chemically or enzymatically modify or reduce various non-rubber components, or the rubber molecules themselves may be modified with various monomers or other chemical groups such as chlorine. Other examples include epoxidized natural rubber and natural rubber having a nitrogen content of at most 0.3 wt. %, as described in PCT Publ. No. WO 2017/207912.

The at least one filler can be selected from carbonaceous materials, carbon black, silica, nanocellulose, lignin, clays, nanoclays, metal oxides, metal carbonates, pyrolysis carbon, reclaimed carbon, recovered carbon black (e.g., as defined in ASTM D8178-19, rCB), graphenes, graphene oxides, reduced graphene oxide (e.g., reduced graphene oxide worms as disclosed in PCT Publ. No. WO 2019/070514A1, the disclosure of which is incorporated by reference herein), or densified reduced graphene oxide granules (as disclosed in U.S. Prov. Appl. No. 62/857,296, filed Jun. 5, 2019, and PCT Publ. No. WO 2020/247681, the disclosures of which are incorporated by reference herein), carbon nanotubes, single-wall carbon nanotubes, multi-wall carbon nanotubes, or combinations thereof, or corresponding coated materials (e.g., silicon-treated carbon black) or chemically-treated materials thereof (e.g., chemically-treated carbon black). Other suitable fillers include carbon nanostructures (CNSs, singular CNS), a plurality of carbon nanotubes (CNTs) that are crosslinked in a polymeric structure by being branched, e.g., in a dendrimeric fashion, interdigitated, entangled and/or sharing common walls with one another. CNS fillers are described in U.S. Pat. No. 9,447,259, and PCT Appl. No. PCT/US2021/027814, the disclosures of which are incorporated by reference herein. Blends of can also be used, e.g., blends of silica and carbon black, silica and silicon-treated carbon black, and carbon black and silicon-treated carbon black. The filler can be chemically treated (e.g. chemically treated carbon black, chemically treated silica, silicon-treated carbon black) and/or chemically modified. The filler can be or include carbon black having an attached organic group(s). The filler can have one or more coatings present on the filler (e.g. silicon-coated materials, silica-coated material, carbon-coated material). The filler can be oxidized and/or have other surface treatments. There is no limitation with respect to the type of filler (e.g., silica, carbon black, or other filler) that can be used.

The filler in general, can be any conventional filler used with elastomers such as reinforcing fillers including, but not limited to, carbon black, silica, a filler comprising carbon black, a filler comprising silica, and/or any combinations thereof. The filler can be particulate or fibrous or plate-like. For example, a particulate filler is made of discrete bodies. Such fillers can often have an aspect ratio (e.g., length to diameter) of 3:1 or less, or 2:1 or less, or 1.5:1 or less. Fibrous fillers can have an aspect ratio of, e.g., 2:1 or more, 3:1 or more, 4:1 or more, or higher. Typically, fillers used for reinforcing elastomers have dimensions that are microscopic (e.g., hundreds of microns or less) or nanoscale (e.g., less than 1 micron). In the case of carbon black, the discrete bodies of particulate carbon black refer to the aggregates or agglomerates formed from primary particles, and not to the primary particles themselves. In other embodiments, the filler can have a platelike structure such as graphenes and reduced graphene oxides.

The filler can comprise a fibrous filler including natural fibers, semi-synthetic fibers, and/or synthetic fibers (e.g., nanosized carbon filaments), such as short fibers disclosed in PCT Publ. No. WO 2021/153643, the disclosure of which is incorporated by reference herein. Other fibrous fillers include poly(p-phenylene terephthalamide) pulp, commercially available as Kevlar® pulp (Du Pont).

Other suitable fillers include bio-sourced or bio-based materials (derived from biological sources), recycled materials, or other fillers considered to be renewable or sustainable include hydrothermal carbon (HTC, where the filler comprises lignin that has been treated by hydrothermal carbonization as described in U.S. Pat. Nos. 10,035,957, and 10,428,218, the disclosures of which are incorporated by reference, herein), rice husk silica, carbon from methane pyrolysis, nanocrystalline cellulose starch particles, polysaccharides, glucans, dextrans, microfibrillated cellulose, engineered polysaccharide particles, starch, siliceous earth, crumb rubber, and functionalized crumb rubber. Exemplary engineered polysaccharides include those described in U.S. Pat. Publ. Nos. 2020/0181370 and 2020/0190270, the disclosures of which are incorporated herein by reference. For example, the polysaccharides can be selected from: poly alpha-1,3-glucan; poly alpha-1,3-1,6-glucan; a water insoluble alpha-(1,3-glucan) polymer having 90% or greater α-1,3-glycosidic linkages, less than 1% by weight of alpha-1,3,6-glycosidic branch points, and a number average degree of polymerization in the range of from 55 to 10,000; dextran; a composition comprising a poly alpha-1,3-glucan ester compound; and water-insoluble cellulose having a weight-average degree of polymerization (DPw) of about 10 to about 1000 and a cellulose II crystal structure.

The carbon black can be a furnace black, a gas black, a thermal black, an acetylene black, or a lamp black, a plasma black, a recovered carbon black (e.g., as defined in ASTM D8178-19), or a carbon product containing silicon-containing species, and/or metal containing species and the like. The carbon black used in any of the methods disclosed herein can be any grade of reinforcing carbon blacks and semi-reinforcing carbon blacks. Examples of ASTM grade reinforcing grades are N110, N121, N134, N220, N231, N234, N299, N326, N330, N339, N347, N351, N358, and N375 carbon blacks. Examples of ASTM grade semi-reinforcing grades are N539, N550, N650, N660, N683, N762, N765, N774, N787, N990 carbon blacks and/or N990 grade thermal blacks.

The carbon black can have any statistical thickness surface area (STSA) such as ranging from 20 m²/g to 250 m²/g or higher. STSA (statistical thickness surface area) is determined based on ASTM Test Procedure D-5816 (measured by nitrogen adsorption). The carbon black can have a compressed oil absorption number (COAN) ranging from about 30 mL/100 g to about 150 mL/100 g. Compressed oil absorption number (COAN) is determined according to ASTM D3493. As an option, the carbon black can have a STSA ranging from 20 m²/g to 180 m²/g, or from 60 m²/g to 150 m²/g with a COAN ranging from 40 mL/100 g to 115 mL/100 g or from 70 mL/100 g to 115 mL/100 g.

As stated, the carbon black can be a rubber black, and especially a reinforcing grade of carbon black or a semi-reinforcing grade of carbon black. Carbon blacks sold under the Regal®, Black Pearls®, Spheron®, Sterling®, Propel®, Endure®, and Vulcan® trademarks available from Cabot Corporation, the Raven®, Statex®, Furnex®, and Neotex® trademarks and the CD and HV lines available from Birla Carbon (formerly available from Columbian Chemicals), and the Corax®, Durax®, Ecorax®, and Purex® trademarks and the CK line available from Orion Engineered Carbons (formerly Evonik and Degussa Industries), and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed. Carbon blacks having surface areas and structures beyond the ASTM grades and typical values selected for mixing with rubber, such as those described in U.S. patent application Publ. No. 2018/0282523, the disclosure of which is incorporated herein by reference, may be used.

With regard to the filler, as an option, being at least silica, one or more types of silica, or any combination of silica(s), can be used in any embodiment disclosed herein. The silica can include or be precipitated silica, fumed silica, silica gel, and/or colloidal silica. The silica can be or include untreated silica and/or chemically-treated silica. The silica can be suitable for reinforcing elastomer composites and can be characterized by a Brunaur Emmett Teller surface area (BET, as determined by multipoint BET nitrogen adsorption, ASTM D1993) of about 20 m²/g to about 450 m²/g; about 30 m²/g to about 450 m²/g; about 30 m²/g to about 400 m²/g; or about 60 m²/g to about 250 m²/g, from about 60 m²/g to about 250 m²/g, from about 80 m²/g to about 200 m²/g. The silica can have an STSA ranging from about 80 m²/g to 250 m²/g, such as from about 80 m²/g to 200 m²/g or from 90 m²/g to 200 m²/g, from 80 m²/g to 175 m²/g, or from 80 m²/g to 150 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such dispersion determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP, 1115 MP, Premium, and 1200 MP silica from Solvay S.A., Hi-Sil® EZ 160G silica from PPG Industries, Inc., and Zeopol® 8741 or 8745 silica from Evonik Industries. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, and Hi-Sil® 243 silica from PPG Industries, Inc. Precipitated silica with surface attached silane coupling agents may also be used. Examples of commercial grades of chemically-treated precipitated silica include Agilon®400, 454, or 458 silica from PPG Industries, Inc. and Coupsil silicas from Evonik Industries, for example Coupsil® 6109 silica.

The carbon black can be a multi-phase aggregate comprising at least one carbon phase and at least one metal-containing species phase or silicon-containing species phase, i.e., silicon-treated carbon black. In silicon-treated carbon black, a silicon containing species, such as an oxide or carbide of silicon, is distributed through at least a portion of the carbon black aggregate as an intrinsic part of the carbon black. Silicon-treated carbon blacks are not carbon black aggregates which have been coated or otherwise modified, but actually represent dual-phase aggregate particles. One phase is carbon, which will still be present as graphitic crystallite and/or amorphous carbon, while the second phase is silica, and possibly other silicon-containing species). Thus, the silicon-containing species phase of the silicon treated carbon black is an intrinsic part of the aggregate, distributed throughout at least a portion of the aggregate. Ecoblack™ silicon-treated carbon blacks are available from Cabot Corporation. The manufacture and properties of these silicon-treated carbon blacks are described in U.S. Pat. No. 6,028,137, the disclosure of which is incorporated herein by reference.

The silicon-treated carbon black can include silicon-containing regions primarily at the aggregate surface of the carbon black, but still be part of the carbon black and/or the silicon-treated carbon black can include silicon-containing regions distributed throughout the carbon black aggregate. The silicon-treated carbon black can be oxidized. The silicon-treated carbon black can contain from about 0.1% to about 50% silicon by weight, e.g., from about 0.1% to about 46.6%, from about 0.1% to about 46%, from about 0.1% to about 45%, from about 0.1% to about 40%, from about 0.1% to about 35%, from about 0.1% to about 30%, from about 0.1% to about 25%, from about 0.1% to about 20%, from about 0.1% to about 15%, from about 0.1% to about 10%, from about 0.1% to about 5%, or from about 0.1% to about 2% by weight, based on the weight of the silicon-treated carbon black. These amounts can be from about 0.5 wt. % to about 25 wt. %, from about 1 wt. % to about 15 wt. % silicon, from about 2 wt. % to about 10 wt. %, from about 3 wt. % to about 8 wt. %, from about 4 wt. % to about 5 wt. % or to about 6 wt. %, all based on the weight of the silicon-treated carbon black.

In any embodiment and in any step, a coupling agent can be introduced in any of the steps (or in multiple steps or locations) as long as the coupling agent has an opportunity to become dispersed in the composite. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl)tetrasulfane (e.g., Si 69 from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi(3-mercapto) propionato-O,N,N′-bis(2-methyl-2-nitropropyl)-1,6-diaminohexane, S-(3-(triethoxysilyl) propyl) octanethioate (e.g., NXT coupling agent from Momentive, Friendly, WV), and/or coupling agents that are chemically similar or that have the one or more of the same chemical groups. Additional specific examples of coupling agents, by commercial names, include, but are not limited to, VP Si 363 from Evonik Industries, and NXT Z and NXT Z-50 silanes from Momentive. Other compounds that can function as coupling agents include those compounds having a nitroxide radical, e.g., TEMPO (2,2,6,6-tetramethyl-1-piperidinyloxy radical), as disclosed in U.S. Pat. Nos. 6,084,015, 6,194,509, 8,584,725, and U.S. Publ. No. 2009/0292044, the disclosures of which are incorporated by reference herein, or nitrile oxide, nitrile imine and nitrone 1,3-dipolar compounds, as disclosed in U.S. Pat. Nos. 10,239,971, 10,202,471, 10,787,471, and U.S. Publ. No. 2020/0362139, the disclosures of which are incorporated by reference herein. The coupling agents described herein could be used to provide hydrophobic surface modification of silica (precoupled or pretreated silica) before using it in any of the processes disclosed herein. It is to be appreciated that any combination of elastomers, additives, and additional composite may be added to the elastomer composite, for instance in a compounder.

As another option, the mixing (e.g., where the filler comprises silica and/or silicon-treated carbon black) can be performed without coupling agents. Optionally, a coating agent (filler coating agent) can be introduced in any of the steps (or in multiple steps or locations) prior to discharging. Methods of mixing without coupling agents and/or with coating agents, including exemplary coating agents, are disclosed in PCT Publication No. WO 2022/125675, the disclosure of which is incorporated by reference herein.

The total loading level of the filler (single filler type or blend fillers) can be at least 20 phr, at least 30 phr, or at least 40 phr. As an option, the total loading level of the filler can range from 20 phr to 250 phr, 30 phr to 250 phr, from 30 phr to 200 phr, from 30 phr to 180 phr, from 30 phr to 150 phr, from 30 phr to 100 phr, from 30 phr to 90 phr, from 30 phr to 80 phr, from 30 phr to 70 phr, from 30 phr to 65 phr, from 30 phr to 60 phr, from 30 phr to 50 phr, from 40 phr to 250 phr, from 40 phr to 200 phr, from 40 phr to 180 phr, from 40 phr to 150 phr, from 40 phr to 100 phr, from 40 phr to 90 phr, from 40 phr to 80 phr, from 40 phr to 70 phr, from 40 phr to 65 phr, or from 40 phr to 60 phr.

In some embodiments at least 50% of the filler (e.g., at least 75% or at least 90% of the filler) is selected from carbon black, and coated and treated materials thereof. In certain embodiments at least 50% of the filler (e.g., at least 75% or at least 90% of the filler) is silica. In certain embodiments at least 50% of the filler (e.g., at least 75% or at least 90% of the filler) is silicon-treated carbon black. As an example, the carbon black can be dispersed in the elastomer at a loading ranging from 30 phr to 200 phr, from 30 phr to 70 phr, or from 40 phr to 65 phr, or from 40 phr to 60 phr. As a more specific example, with the elastomer being natural rubber alone or with one or more other elastomers, and the filler being carbon black alone or with one or more other fillers (e.g., silica or silicon-treated carbon black), the carbon black can be dispersed in the natural rubber at a loading ranging from 30 phr to 70 phr, or from 40 phr to 65 phr, or from 40 phr to 60 phr.

In some embodiments at least 50% of the filler (e.g., at least 75% or at least 90% of the filler) is selected from silica. The amount of silica present in the elastomer composite formed can be from 20 phr to 250 phr, from 20 phr to 200 phr, from 20 phr to 150 phr, from 20 phr to from 100 phr, from 30 phr to from 150 phr, from 30 phr to from 100 phr, from 25 phr to 100 phr, from 25 phr to 80 phr, from 35 phr to 115 phr, from 35 phr to 100 phr, from 40 phr to 110 phr, from 40 phr to 100 phr, from 40 phr to 90 phr, from 40 phr to 80 phr, and the like. Filler blends comprising silica can include 10 wt. % carbon black and/or silicon-treated carbon black.

The amount of silicon-treated carbon black present in the elastomer composite formed can be from 20 phr to 250 phr, from 20 phr to 200 phr, from 30 phr to 150 phr, from 40 phr to 100 phr, or from 50 phr to 65 phr.

In some embodiments, the extruder is configured to extrude elastomeric that are difficult to process with existing or conventional equipment, e.g., twin-screw rollers (TSR) and stationary knife device design(s). For example, certain elastomeric compositions can be tough to cut into discrete pieces. In some embodiments, the elastomeric compositions can have a dynamic storage modulus of at least 900 kPa, measured at 0.3% strain amplitude, G′ (0.3%), e.g., a dynamic storage modulus of at least 1000 kPa, e.g., ranging from 900 kPa to 3000 kPa or from 1000 kPa to 3000 kPa or from 900 kPa to 2500 kPa or from 1000 kPa to 2500 kPa at 1 Hz frequency and 100° C. Dynamic storage modulus can be measured with known equipment to determine rheological properties, e.g., a rubber process analyzer (RPA; D-RPA 3000, MonTech Rubber Testing Solutions) at 0.3% strain under the conditions of 100° C. at a shear frequency of 1 Hz after pre-conditioning after 5 min static conditioning, 10 cycles of shearing at 50% strain, and a 30 min recovery at 0.3% strain.

In some embodiments, the elastomeric extrudate is substantially free of rubber chemicals. Most elastomer compositions are prepared by dry mixing elastomer and filler in the presence of rubber chemicals. In typical dry mixing processes, one or more rubber chemicals (e.g., processing aids) are charged early in the mix cycle to aid incorporation of the filler. Rubber chemicals can be essential, yet they can interfere with binding or interaction between filler and elastomer surfaces and can have a negative impact on vulcanizate properties. It has been discovered that mixing solid elastomer with a wet filler enables mixing in the absence of or substantial absence of such rubber chemicals. Without wishing to be bound by any theory, it is believed that the presence of a wet filler eliminates the need for rubber chemicals early in the mix cycle, or anytime during the mix cycle, because the liquid from the wet filler enables longer mixing times, thereby improving filler incorporation into the solid rubber without the potential interference of rubber chemicals.

The mixing of wet filler with solid elastomer is described in PCT Publ. No. WO 2020/247663, the disclosure of which is incorporated by reference herein. Mixing with wet filler provides liquid to the mixture, which enables the batch time and temperature to be controlled beyond that attainable with known dry mixing processes. Control of batch time optimizes filler incorporation and dispersion in a manner not possible with dry mixing due to the potential degradation of the elastomer, such as natural rubber. The additional feature of mixing in the substantial absence of rubber chemicals can provide a further enhancement. Other benefits may be attained when mixing wet filler with solid elastomer, compared to dry mixing, such as enhancing filler dispersion and/or facilitating rubber-filler interactions and/or improving rubber compound properties.

### As an Option, the Elastomer Composite can be Prepared by a Method Comprising:

(a) charging a mixer having one or more rotors with at least a solid elastomer and a wet filler comprising a filler and a liquid present in an amount of at least 15% by weight based on total weight of wet filler; (b) in one or more mixing steps, mixing the at least the solid elastomer and the wet filler to form a mixture and removing at least a portion of the liquid from the mixture by evaporation, and in at least one of said mixing steps conducting said mixing wherein at least one of the following applies:
   (i) the mixer has at least one temperature-control means that is set to a temperature, Tz, of 65° C. or higher, and
   (ii) the one or more rotors operate, for at least 50% the mixing time, at a tip speed of at least 0.6 m/s; and
(c) discharging, from the mixer, the composite comprising the filler dispersed in the elastomer at a loading of at least 20 phr wherein the composite has a liquid content of no more than 10% by weight based on total weight of said composite. The mixing can be performed in one, two, three, or more mixing steps.

Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphonamides and thiazoles), vulcanizing agents (or curatives, to crosslink rubbers, e.g. sulfur, peroxides), and other rubber additives, such as, but not limit to, retarders, co-agents, peptizers, adhesion promoters, tackifiers, resins, flame retardants, colorants, and blowing agents. As an option, the rubber chemicals can comprise processing aids and activators. As another option, the one or more other rubber chemicals are selected from zinc oxide, fatty acids, zinc salts of fatty acids, wax, accelerators, resins, and processing oil.

In their dry state, fillers may contain no or small amounts of liquid (e.g. water or moisture) adsorbed onto its surfaces. For example, carbon black can have 0 wt. %, or 0.1 wt. % to 1 wt. % or up to 3 wt. % or up to 4 wt. % of liquid and precipitated silica can have a liquid (e.g., water or moisture) content of from 4 wt. % to 7 wt. % liquid, e.g., from 4 wt. % to 6 wt. % liquid. Such fillers are referred to herein as dry or non-wetted fillers. A “wet filler” comprises a filler and a liquid present on a substantial portion or substantially all the surfaces of the filler, which can include inner surfaces or pores accessible to the liquid. Thus, sufficient liquid is provided to wet a substantial portion or substantially all of the surfaces of the filler prior to mixing with solid elastomer.

The wet filler can have a liquid content of at least 15% by weight relative to the total weight of the wet filler, e.g., at least 20%, at least 25%, at least 30%, at least 40%, at least 50% by weight, or from 15% to 99%, from 15% to 95%, from 15% to 90%, from 15% to 80%, from 15% to 70%, from 15% to 60%, from 15% to 65%, from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60% by weight, relative to the total weight of the wet filler. With these amounts, the wet filler maintains the form of a powder, particulates, pellet, cake, or paste, or similar consistency and/or has the appearance of a powder, particulates, pellet, cake, or paste. In some embodiments, the wet filler is not a slurry of filler and does not have the consistency of a liquid or slurry.

During mixing, at least a portion of the liquid can also be removed by evaporation as the wet filler is being dispersed in the solid elastomer, and the surfaces of the filler can then become available to interact with the solid elastomer. The liquid of the wet filler is thus capable of being removed by evaporation (and at least a portion is capable of being removed under the recited mixing conditions) and can be a volatile liquid, e.g., volatile at bulk mixture temperatures. The volatile liquid can be or include water, e.g., at least 50 wt. % water, at least 75 wt. % water, at least 90 wt. % water, at least 95 wt. % water, at least 99 wt. % water. For example, the liquid can have a boiling point at 1 atm. of 180° C. In some embodiments, the wet filler has the consistency of a solid. As an option, a dry filler is wetted only to an extent such that the resulting wet filler maintains the form of a powder, particulates, pellet, cake, or paste, or similar consistency and/or has the appearance of a powder, particulates, pellet, cake, or paste. The wet filler does not flow like a liquid (at zero applied stress). As an option, the wet filler can maintain a shape at 25° C. when molded into such a shape, whether it be the individual particles, agglomerates, pellets, cakes, or pastes.

In some embodiments when the mixing is performed in the presence of a liquid (e.g., wet filler or coupling agent), the composite to be extruded can have a liquid content (e.g., moisture content where the liquid is water) ranging from 0.3% to 10% by weight, relative to the total weight of the composition (e.g., a composite). In some embodiments, the liquid (moisture) content can range from 0.3% to 7%, from 0.3% to 5%, from 0.3% to 3%, from 0.3% to 2%, from 0.3% to 1%, from 0.5% to 10%, from 0.5% to 7%, from 0.5% to 5%, from 0.5% to 3%, from 0.5% to 2%, from 0.5% to 1% relative to the total weight of the composition. The liquid content of the composite can depend on the mixing stage. For example, in a first mixing stage or with single stage mixing, the liquid content can range from 2% to 10%, from 2% to 7%, from 2% to 5%, from 2% to 3%, from 3% to 10%, from 3% to 7%, or from 3% to 5% relative to the total weight of the composition. A subsequent mixing stage can reduce the liquid content to an amount ranging from 0.3% to 3%, from 0.3% to 2%, from 0.3% to 1%, from 0.5% to 3%, from 0.5% to 2%, or from 0.5% to 1% relative to the total weight of the composition.

As another option, a composite substantially free of rubber chemicals can be prepared by mixing a filler slurry with an elastomer or elastomer source in liquid form, e.g., elastomer solution, emulsion, latex, coagulum, and the like. The elastomer or elastomer source in liquid form can be mixed with the filler slurry in any number of ways known in the art, e.g., solution mixing. For example, the mixing can be a continuous mixing process comprising feeding a continuous flow of a first fluid comprising the elastomer solution or emulsion or latex or coagulum to a mixing zone of a reactor (e.g., an elongate mixing chamber) extending from the mixing zone to a discharge end. In another example, where the elastomer source is a latex, the method can comprise:
feeding a continuous flow of a first fluid comprising elastomer latex to a mixing zone of a coagulum reactor defining an elongate coagulum zone extending from the mixing zone to a discharge end;
feeding a continuous flow of a second fluid comprising particulate filler under pressure to the mixing zone of the coagulum reactor to form a mixture with the elastomer latex, the mixture passing as a continuous flow to the discharge end and the particulate filler being effective to coagulate the elastomer latex, wherein feeding of the second fluid against the first fluid within the mixing zone is sufficiently energetic to substantially completely coagulate the elastomer latex with the particulate filler prior to the discharge end,
discharging a substantially continuous flow of elastomer composite from the discharge end of the coagulum reactor.

In some embodiments, the elastomer composite or extrudate substantially free of rubber chemicals, or having the substantial absence of rubber chemicals, has a total amount of rubber chemicals less than 5 phr or less, 4 phr or less, 3 phr or less, 2 phr or less, 1 phr or less, or 0.5 phr or less, 0.2 phr or less, 0.1 phr or less.

In some embodiments, the elastomer composite can be characterized by a dynamic storage modulus of at least 900 kPa measured at 0.3% strain amplitude, G′ (0.3%).

The present processing methods result in a form of extrudates, e.g., dimensions, curvature, etc., that enable further processing of the composite, e.g., compounding to include rubber chemicals after much of the filler has been dispersed in the elastomer.

In some embodiments, the elastomer composite or extrudate consists of or consists essentially of at least one solid elastomer and at least one filler. In some embodiments, the composite or extrudate can further comprise at least one antidegradant (e.g., antioxidant) and/or at least one coupling agent. Accordingly, in some embodiments, the elastomer composite or extrudate consists of or consists essentially of at least one elastomer, at least one filler, and at least one antidegradant. In other embodiments, the elastomer composite or extrudate consists of or consists essentially of at least one elastomer, at least one filler, and at least one coupling agent. In yet other embodiments, the elastomer composite or extrudate consists of or consists essentially of at least one elastomer, at least one filler, at least one antidegradant, and at least one coupling agent. Such composites can be prepared from mixing of solid elastomer with filler and liquid (e.g., wet filler or filler and liquid added separately) or from the mixing of filler slurry with elastomer or elastomer source in liquid form, e.g., elastomer solution, latex, emulsion, and the like.

As such, the elastomeric extrudate, as discussed herein, may be used to produce an elastomer or rubber containing product, e.g., elastomer composite. In an embodiment, the elastomer composite may be used in or produced for use, e.g., to form a vulcanizate to be incorporated in various parts of a tire, for example, tire treads, including cap and base, undertread, innerliners, tire sidewalls, tire carcasses, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, weather stripping, windshield wipers, automotive components, liners, pads, housings, wheel and track elements, tire sidewall inserts, wire-skim for tires, and cushion gum for retread tires, in pneumatic tires as well as non-pneumatic or solid tires. Alternatively or in addition, elastomer composite (and subsequently vulcanizate) may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. Further the elastomer composite, via the vulcanized elastomer composite, may be used in rollers, cams, shafts, pipes, bushings for vehicles, or other applications where abrasion resistance and/or enhanced dynamic properties are desired.

### EXAMPLES

These Examples describe the preparation of elastomeric compositions comprising filler followed by extrusion and cutting.

### Preparation of Elastomeric Compositions

Elastomer composites were prepared by mixing natural rubber (STR20), with wet carbon black filler to target a filler loading of 55 phr. The wet carbon black filler was prepared by milling Propel® E7 carbon black (Cabot Corporation) and re-wetting in a pin pelletizer, resulting in moisture content of about 57%. The natural rubber used was standard grade natural rubber STR20 (Thailand). Technical descriptions of these natural rubbers are widely available, such as in Rubber World Magazine's Blue Book published by Lippincott and Peto, Inc. (Akron, Ohio, USA).

All composites were prepared through a two-stage mixing process. The first stage to mix wet filler and elastomer was conducted on a BB-16 tangential mixer (“BB-16”; Kobelco Kobe Steel Group) fitted with two 6-wing tangential rotors (type 6WI), providing 14.4 L capacity. Because of the steam released by the use of wet filler, the mixer included an inlet and outlet with a gas flow rate of 1095 Nm³/h, as described in U.S. Provisional Application No. 63/707,346, filed Oct. 15, 2024, at FIG. 1 and accompanying descriptions including paragraph [0106], the disclosure of which is incorporated by reference herein.

The mixing was performed with power PID control after each addition of the filler. The proportional constant was 7.5%, the integral constant was 0.3 s, and no derivative control was used. The power set point was 90 KW and the maximum output of the power PID control loop was set to 100 rpm. The power input signal used by the power PID control loop was filtered by using a Kalman filter with a K2 constant of 0.005 (see Appendix 1). The control system performed these calculations approximately every 0.2 s. First stage conditions were: TCU temperature=90° C.; fill factor=66%; ram pressure=95 psig.

In the second stage, the composite from the stage 1 mixing was combined with N-(1,3-dimethylbutyl)-N′-phenyl-p-phenylenediamine (6PPD, 2 phr in a BB-16 tangential mixer (“BB-16”) fitted with two 6-wing tangential rotors under the following conditions: TCU temperature=90° C.; fill factor=44%; ram pressure=95 psig. The mixing was performed with power PID control in which the proportional constant was 0.5% (step 5) and 1.25 (step 6), the integral constant was 0.1 s, and no derivative control was used; Kalman filter had a K2 constant of 0.005. Stage 1 and 2 mixing procedures are shown in Tables 1 and 2, respectively, where “Time” refers to time of each step. The total stage 1 and 2 mixing times were 8.7 min. and 5 min. respectively, resulting in a composite moisture content of 5.4 wt. % and 0.3 wt. %, respectively. The probe temperatures were 119° C. for stage 1 and 144° C. for stage 2 composites.

TABLE 1

| | | Time | Temp | Ram | | rpm | rpm |
|---|---|---|---|---|---|---|---|
| Step | Description | (s) | (° C.) | Position | Rpm | (min) | (max) |
| 1 | Add 50% Polymer - 75% Filler - | — | — | Up | 50 | — | — |
| | then remaining 50% Polymer | | | | | | |
| 2 | Masticate to target time or | 20 | 120 | Down | 60 | — | — |
| | temperature | | | | | | |
| 3 | Mix under power PID control | | 125 | Down | | 50 | 100 |
| | until 125° C. | | | | | | |
| 5 | Speed Reduction | 10 | — | Up | 20 | — | — |
| 6 | Add remaining 25% Filler | 20 | — | Up | 20 | — | — |
| 7 | Mix under power PID control | | 135 | Down | Power | 50 | 110 |
| | until stated temperature | | | | PID | | |
| 8 | Mix under power PID control | | 150 | Down | Power | 50 | 110 |
| | until stated temperature | | | | PID | | |
| 10 | Vent Mixer | 15 | — | Down | 60 | — | — |
| 11 | Discharge Mixer & close Drop | 15 | — | Floating | 50 | — | — |
| | Door | | | | | | |

TABLE 2

| | | Time | Temp | Ram | | rpm | rpm |
|---|---|---|---|---|---|---|---|
| Step | Description | (s) | (° C.) | Position | rpm | (min) | (max) |
| 1 | Feed master-batch and 6PPD | — | — | Up | 35 | — | — |
| 2 | Masticate masterbatch | 30 | — | Down | 20 | — | — |
| 3 | Masticate at fixed speed with | 240 | 110 | Down | 20 | — | — |
| | ram down until stated | | | | | | |
| | temperature | | | | | | |
| 4 | Lift ram | — | — | Up | 20 | — | — |
| 5 | Mix under power PID until | | 130 | Up | Power | 10 | 50 |
| | stated temperature | | | | PID | | |
| 6 | Mix under power PID until | | 135 | Up | Power | 10 | 50 |
| | stated temperature | | | | PID | | |
| 8 | Discharge mixer & close drop | 30 | — | Up | 30 | — | — |
| | door | | | | | | |

### Extruding of Elastomeric Compositions

The composites discharged from the stage 1 and stage 2 mixing were processed in a TSR-125 twin-screw discharger extruder (Kobelco Kobe Steel Group) in which the twin screw is schematically depicted in FIG. 2 and the flat face of the screw schematically depicted in FIG. 6C. The twin-screw was fitted with a die plate as illustrated in FIGS. 3A-3C. Tables 3 and 4 list the dimensions of the twin screw extruder and die plate, respectively.

TABLE 3

| Twin-screw extruder | Dimension | |
|---|---|---|
| I.D. of TSR Outlet | 122.7 | mm |
| O.D. of Rotor Shaft | 60 | mm |
| Max O.D. of Screw Flight | 110 | |
| Total Exit Area | 9505.3 | mm² |
| Total Area of Screw Flight Flat Face (FIG. 6C) × 2 | 3684.2 | mm² |
| Area of Screw Flight Flat Face/Total TSR Exit Area | 68.8% | |
| Screw Flat Face angle, α (FIG. 6C) | 90° | |
| Screw Flat Face Distance, L (FIG. 6C) | 55 | mm |

TABLE 4

| Die Plate | Dimension | |
|---|---|---|
| Thickness | 17.5 | mm |
| Die plate length | 405 | mm |
| Die plate width | 190 | mm |
| Angle of slots, β (FIG. 3A) | 37.5° | |
| Max. O.D. of knife holes | 110 | mm |
| No. holes/twin-screw (2 × 8) | 16 | |
| Radial width of each hole | 9.3 | mm |
| Circumferential length of each hole | 35.4 | mm |
| Area of each hole | 311 | mm² |
| Total Hole Area | 4970.5 | mm² |

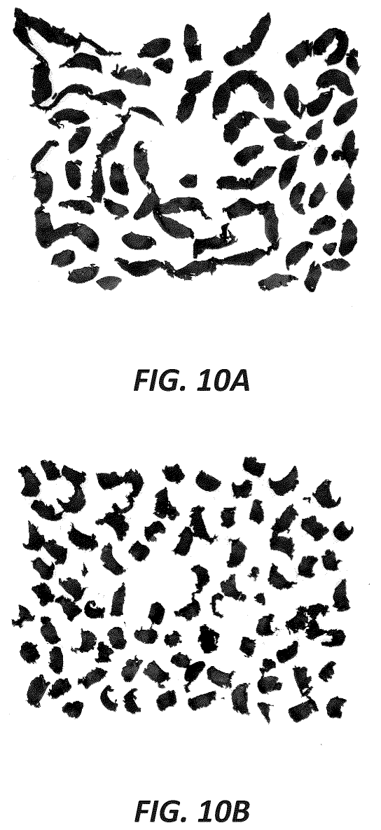

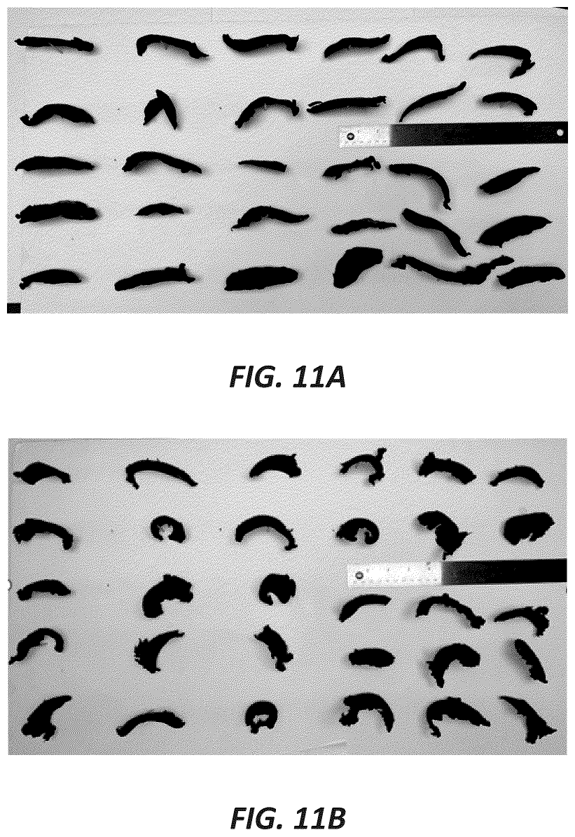

Extrusion was performed with a set of intermesh twin screw rotors where TCU temperature was set at 90° C. and the die plate set to a temperature of 150° C., and the extruder operating at 32.5 rpm. Photographs of the resulting extrudates are shown in FIGS. 10A (1st stage) and 10B (2nd stage). Length and width of the extrudate was determined with ImageJ software available from https://imagej.net/according to ISO 9276-6:2008.

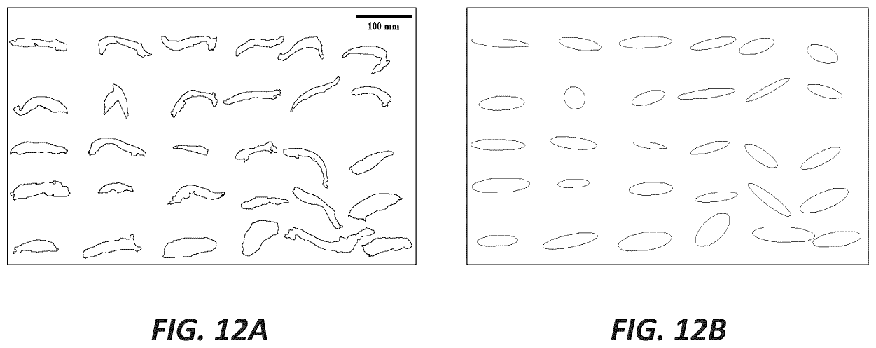

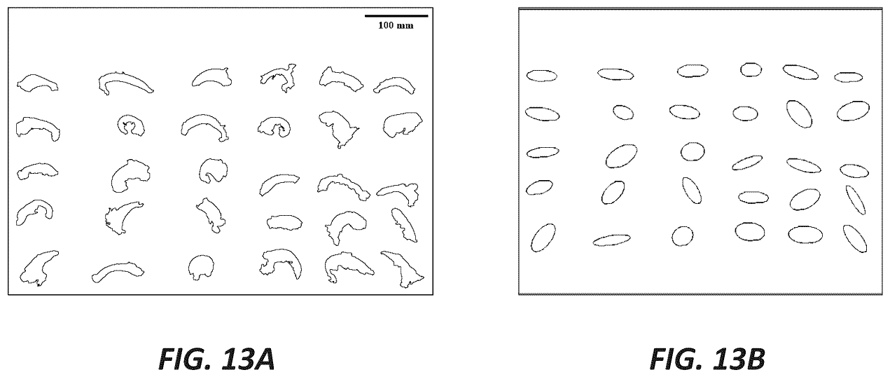

Representative extrudates were prepared for image analysis as shown in the photographs of FIG. 11A (1st stage) and 11B (2nd stage). These extrudates were also used to measure thickness by hand along and across the extrudate using a caliper. To measure the angle of curvature, outlines of each extrudate was obtained and their fitted ellipses were calculated with ImageJ software. The outlines of the extrudates and corresponding ellipses are depicted in FIGS. 12A and 12B for first stage composites and in FIGS. 13A and 13B for second stage composites. The angle of curvature was calculated as shown in FIG. 8A and accompanying discussion.

Table 5 summarizes the length, width, thickness, and angle of curvature of the stage 1 and stage 2 composites.

TABLE 5

| | | Mini- | Maxi- | 75th | 90th |
|---|---|---|---|---|---|
| Composite | Measurement | mum | mum | Percentile | Percentile |
| Stage 1 | Length (mm) | 21.1 | 443.2 | 133.8 | 287.1 |
| Stage1 | Width (mm) | 8.2 | 232.7 | 57.9 | 122.3 |
| Stage 2 | Length (mm) | 23.1 | 166.4 | 86.3 | 116.5 |
| Stage 2 | Width (mm) | 15.7 | 109.3 | 53.4 | 65.4 |
| Stage 1 | Thickness (mm) | 5.0 | 7.9 | 6.5 | 7.7 |
| Stage 2 | Thickness (mm) | 5.1 | 8.5 | 7.5 | 8.1 |
| Stage 1 | Angle of curvature | 96.9 | 166.5 | 159.1 | 164.8 |
| | (degrees) | | | | |
| Stage 2 | Angle of curvature | 98.3 | 156.4 | 143.2 | 152 |
| | (degrees) | | | | |

It can be seen that all the extrudates had a maximum dimension (length) less than 500 mm, in which 90 percent of the extrudates had a length below 300 mm. The angle of curvatures for at least 75% of the extrudates were below 160°. It can be seen that the amount of water affects the size of the extrudates: the stage 1 extrudates, with higher moisture content had larger lengths, widths, and angles of curvature compared to the second stage extrudates. The second stage extrudates had a lower moisture content resulting in generally lower dimensions and angles of curvature. The examples demonstrate that the methods disclosed herein are effective in extruding and cutting elastomer composites, such as composites containing moisture and/or composites having a substantial absence of rubber chemicals, to form extrudates having a maximum dimension (length) no more than 500 mm and in which at least 75% of the extrudates having an angle of curvature no more than 160°.

### Bales

The density of the stage 1 extrudates was determined to be (1110 Kg/m³). The weight of the extrudates required to fill a metal container having a volume of 0.018 m³ amounted to 5.6 kg. Theoretically, the bag containing solid extrudate would weigh 20 kg. Thus, the volume filled by 5.6 kg of extrudate was 18%; conversely, the void volume was 72%. In contrast, the void volume achieved with extrudates that were cut with a granulator that cut sheets into fritters had a maximum of 40%. It can be seen that the extrudates cut by the present methods yielded bales that had a much greater void volume than achieved by prior art methods.

### APPENDIX 1: KALMAN FILTER DESCRIPTION

### Variables:

P=process variable (to be filtered by control system)
E=filtered estimate of P
(calculated by the control system for each time increment of x)
R=rate of change of P with time
(calculated by control system for each time increment of x)
t=time
x=increment of time used by control system (for data input, calculations and data output)
K2=filter constant input by user into control system
K1=filter constant calculated from K2

### Working Equations:

$$K 1 = 2 ( K 2 ) ** 0.5 - K 2$$

$$Et = Et - x + Rt - x + K 1 ( Pt - Et - x - Rt - x )$$

$$Rt = Rt - x + K 2 ( Pt - Et )$$

### Notes:

Initial estimates of E and R have to be made (values of 0 are often acceptable). K2 is empirically selected by user to obtain the desired filtering of P.

1. A method for processing a composition, the method comprising:
feeding the composition to a screw extruder, wherein the composition comprises at least one elastomer and at least one filler;
flowing the composition through the extruder by applying a shearing force on the composition; and
extruding the composition through a stationary die provided at an exit end of the extruder, wherein the extruding comprises:
forcing the composition through at least one non-circular slot extending through a die body of the stationary die from a first face of the die body to an opposing face of the die body that opposes the first face forming a passageway such that the composition is forced across an inner surface of the at least one non-circular slot, wherein the inner surface is tapered such that a first opening at one of the first face or the opposing face is smaller than a second opening at the other of the first face or the opposing face.

2. A method for processing a composition, the method comprising:
feeding the composition to a screw extruder, wherein the composition comprises at least one elastomer and at least one filler;
flowing the composition through the extruder by applying a shearing force on the composition; and
extruding the composition through a stationary die provided at an exit end of the extruder, wherein the extruding comprises:
forcing the composition through at least one slot extending through a die body of the stationary die from a first face of the die body to an opposing face of the die body that opposes the first face forming a passageway such that the composition is forced across an inner surface of the at least one slot, wherein the inner surface is tapered such that a first opening at one of the first face or the opposing face is smaller than a second opening at the other of the first face or the opposing face, and wherein the first and second openings are non-concentric.

3. A method for processing a composition, the method comprising:
feeding the composition to a screw extruder, wherein the composition comprises at least one elastomer and at least one filler having a filler loading of at least 20 phr, wherein the composition is substantially free of rubber chemicals;
flowing the composition through the extruder by applying a shearing force on the composition;
extruding the composition through a die provided at an exit end of the extruder, wherein the die comprises a die body having a first face and an opposing face, wherein the extruding includes traversing the composition through at least one slot extending through the die body from the first face to the opposing face that forms a passageway; and
cutting the extruded composition with an associated blade of the die, wherein one or more of the die or the associated blade is rotatable.

4. The method of claim 3, wherein an inner surface of the slot is tapered such that a first opening at one of the first face or the opposing face is smaller than a second opening at the other of the first face or the opposing face.

5. (canceled)

6. The method of claim 1, wherein the first and second openings are non-concentric.

7. The method of claim 1, wherein the first and second openings are concentric.

8. (canceled)

9. The method of claim 1, wherein first opening is at the first face such that the slot is tapered outward.

10. The method of claim 1, wherein the first opening is at the opposing face such that the slot is tapered inward.

11. The method of claim 1, wherein the taper of the inner surface of the at least one slot is configured to maintain the composition on a cutting edge of the at least one slot that substantially aligns with a direction of a vector combining tangential and radial forces imposed on the composition being extruded through the die.

12. (canceled)

13. The method of claim 1, wherein at least one wall of the tapered inner surface of the at least one slot is bevelled.

14. The method of claim 1, wherein a cross-section of the inner surface of the slot defines taper angle ranging from 20° to 60°.

15-16. (canceled)

17. The method of claim 1, wherein the at least one slot is configured to substantially align with a direction of a vector combining tangential and radial forces on the composition being extruded through the die from the extruder.

18. The method of claim 1, wherein the at least one slot has an elongated shape.

19. The method of claim 1, wherein the at least one slot has an elliptical or ovular shape.

20. The method of claim 1, wherein at least one of the first and second openings of the at least one slot has a stadium shape with two parallel linear edges.

21. The method of claim 1, wherein a center line aligned with longest dimension of the at least one slot is offset from an axial axis of a corresponding screw of the extruder.

22. The method of claim 1, wherein a center line aligned with longest dimension of the at least one slot is offset from an axial axis of a corresponding screw of the extruder by an angle ranging from 20° to 50°.

23-25. (canceled)

26. The method of claim 1, wherein the at least one slot comprises a plurality of slots.

27. The method of claim 26, wherein a number of sets of the plurality of slots correspond to a number of screws provided in the extruder.

28. The method of claim 26, wherein a midpoint of each set of the plurality of slots is substantially coaxially aligned with the corresponding screw provided in the extruder.

29-32. (canceled)

33. The method of claim 1, further comprising a heating element for heating the composition being extruded through the die, wherein the heating element is configured to be heated at a temperature ranging from 90° C. to 150° C.

34-38. (canceled)

39. The method of claim 1, wherein the extruder is configured to maintain a metal temperature of the single screw or twin-screw extruder ranging from 50° C. to 150° C.

40. The method of claim 1, wherein the composition is an elastomer composite.

41. A method of processing a composite in an integrated manufacturing operation, comprising:
feeding the composite to a screw extruder;
flowing the composite through the extruder by applying a shearing force on the composition; and
extruding the composite through a die provided at an exit end of the extruder such that the extruded composite has an irregular shape.

42. (canceled)

43. A method for processing a composition, the method comprising:
feeding the composition to screw extruder, wherein the composition comprises at least one elastomer and at least one filler;
flowing the composition through the extruder by applying a shearing force on the composition, wherein the screw or screws of the extruder each comprise (i) a shaft having a longitudinal axis, a first end, and a second exit end, and (ii) a screw flight provided on the shaft along the longitudinal axis from the first end to the second exit end for applying the shearing force on the composition; and
extruding the composition through a die provided at the second exit end of each screw or screws of the extruder, wherein the second exit end has an end portion with a flat face formed by the shaft and the screw flight, and wherein the flat face has a surface area ranging from 20% to 70% of an area defined by an outer diameter of the screw flight.

44-48. (canceled)

49. A method for processing a composition, the method comprising:
feeding the composition to a screw extruder, wherein the composition comprises at least one elastomer and at least one filler;
flowing the composition through the extruder by applying a shearing force on the composition, wherein the screw or screws of the extruder each comprise (i) a shaft having a longitudinal axis, a first end, and a second exit end, and (ii) screw flight provided on the shaft along the longitudinal axis from the first end to the second exit end for applying the shearing force on the composition; and
extruding the composition through a die provided at the second exit end of the screw or screws, wherein the second exit end has an end portion with a flat face formed by the shaft and the screw flight, and wherein at least a portion of the flat face is configured to have a surface area ranging from 0.9 to 3 times an area of a slot of a die of the extruder.

50-57. (canceled)

58. The method of claim 1, wherein the screw or screws of the extruder each comprise (i) a shaft having a longitudinal axis, and (ii) a screw flight provided on the shaft along the longitudinal axis, wherein adjacent the exit end of the extruder is an end portion of the screw or screws with a flat face formed by the shaft and the screw flight, and wherein the flat face has a surface area ranging from 20% to 70% of an area defined by an outer diameter of the screw flight.

59. The method of claim 1, wherein the screw or screws of the extruder each comprise (i) a shaft having a longitudinal axis, and (ii) a screw flight provided on the shaft along the longitudinal axis, wherein adjacent the exit end of the extruder is an end portion of the screw or screws with a flat face formed by the shaft and the screw flight, and wherein the flat face is configured to have a surface area that is between at or about 0.9 and 3 times an area of the at least one slot.

60. The method of claim 1, wherein the composition has a liquid content ranging from 0.3% to 10% by weight relative to the total weight of the composition.

61. The method of claim 1, wherein the composition consists essentially of:
(i) the at least one elastomer and the at least one filler, or
(ii) the at least one elastomer, the at least one filler, and at least one antidegradant, or
(iii) the at least one elastomer, the at least one filler, and at least one coupling agent, or
(iv) the at least one elastomer, the at least one filler, at least one antidegradant, and at least one coupling agent.

62. The method of claim 1, wherein the composition consists of:
(i) the at least one elastomer and the at least one filler, or
(ii) the at least one elastomer, the at least one filler, and at least one antidegradant, or
(iii) the at least one elastomer, the at least one filler, and at least one coupling agent, or
(iv) the at least one elastomer, the at least one filler, at least one antidegradant, and at least one coupling agent.

63. An elastomeric extrudate comprising at least one elastomer and at least one filler in an amount of at least 20 phr, wherein the extrudate has:
a length no more than 500 mm; and
an angle of curvature in at least one dimension ranging from 50° to 160°.

64-85. (canceled)

86. A plurality of elastomeric extrudes each having an irregular shape and comprising at least one elastomer and at least one filler in an amount of at least 20 phr, wherein:
at least 75% of the plurality of extrudates has a length no more than 500 mm; and
at least 75% of the plurality of elastomeric extrudates has an angle of curvature in at least one dimension ranging from 50° to 160°.

87-89. (canceled)

90. A bale comprising the plurality of elastomeric extrudates of claim 86, wherein the bale has a void volume ranging from 50% to 90%.

91. A method for extruding a material, the method comprising:
feeding the material to a screw extruder;
flowing the material through the extruder by applying a shearing force on the material;
extruding the material through a die plate provided at an exit end of the extruder,
wherein the elastomeric extrudate has an irregular shape, wherein the extrudate has an angle of curvature in at least one dimension ranging from 50° to 160°, and
wherein a length of the extrudate is no more than 500 mm.

92. (canceled)
